(19) United States
(12) Patent Application Publication
(10) Pub. No.: US 2022/0009198 A1
(43) Pub. Date: Jan. 13, 2022

(54) HIGH-STRENGTH LOW-HEAT RELEASE COMPONENTS INCLUDING A RESIN LAYER HAVING SP2 CARBON-CONTAINING MATERIAL THEREIN

(71) Applicant: BRIGHT LITE STRUCTURES LLC, San Fransico, CA (US)

(72) Inventor: Antony Dodworth, Stamford (GB)

(21) Appl. No.: 17/294,981

(22) PCT Filed: Nov. 19, 2019
(86) PCT No.: PCT/US2019/062139

§ 371 Date: May 18, 2021

Related U.S. Application Data
(60) Provisional application No. 62/769,452, filed on Nov. 19, 2018.

(51) Int. Cl. B32B 5/26; B32B 3/12; B32B 3/20; B32B 5/02; B32B 5/18; B32B 5/24; B32B 27/12; B32B 27/28; B32B 37/10; B32B 37/15; B32B 37/14; B32B 37/06; B32B 38/18; B29C 70/02; B29C 70/22; B29C 70/34

(52) U.S. Cl. CPC B32B 5/263; B29L 2031/3005; B32B 3/20; B32B 5/024; B32B 5/18; B32B 5/245; B32B 27/12; B32B 27/281; B32B 27/285; B32B 37/10; B32B 37/15; B32B 37/146; B32B 37/06; B32B 38/1808; B29C 70/025; B29C 70/023; B29C 70/22; B29C 70/34; B32B 2255/02; B32B 2260/023; B32B 2260/046; B32B 2262/101; B32B 2262/106; B32B 2264/108; B32B 2264/501; B32B 2264/502; B32B 2264/201; B32B 2266/0242; B32B 2270/00; B32B 2307/302; B32B 2307/304; B32B 2307/718; B32B 2605/003; B32B 2479/00; B32B 2305/022; B32B 2305/024; B32B 2305/076; B32B 2305/188; B32B 2305/30; B32B 2305/72; B32B 2305/77; B32B 2313/04; B32B 2315/085; B32B 2333/12; B32B 2371/00; B32B 2379/08; B32B 2363/00; B32B 2375/00; B32B 3/12

(57) ABSTRACT

Embodiments disclosed herein relate to composite laminate structures including a polymer layer having sp² carbon-containing material and improved heat release properties, and methods of making the same.

### CROSS-REFERENCE TO RELATED APPLICATIONS

This application claims priority to U.S. Provisional Application No. 62/769,452 filed on 19 Nov. 2018, the disclosure of which is incorporated herein in its entirety by this reference.

### BACKGROUND

Composite components may significantly reduce weight, improve fuel efficiency and reduce carbon emissions compared against monolithic structural parts. Composites may include carbon fibers or glass fibers embedded in a resin. Currently, composite components are often fabricated by conventional molding processes, including resin transfer molding (RTM), sheet molding, etc. Composite components may also be formed of pre-impregnated fibers (“pre-preg”) and may require an oven or autoclave to cure the pre-preg. Traditionally, fiber reinforced composite components are not cost competitive compared to metal components for several reasons.

Composite parts exhibit various heat release values depending upon the material(s) therein. Heat release can be determined by burning a composite component and monitoring the amount of heat produced as the component burns. Epoxy and epoxy resin systems typically burn releasing significant heat. Typically, when a composite component with a relatively low heat release is desired, phenolic resin is used in the composite component because they are inert.

Manufacturers continue to search for materials, low cost tooling, and production techniques to form composite components.

### SUMMARY

Embodiments disclosed herein relate to high-strength low-heat release components including at least one polymer layer having and sp² carbon-containing material therein. In an embodiment, a composite sandwich structure is disclosed. The composite sandwich structure includes a first polymer layer including sp² carbon-containing material therein. The composite sandwich structure includes a second polymer layer disposed on the first polymer layer. The composite sandwich structure includes a core positioned on the second polymer layer, wherein the core includes a plurality of cells. The composite sandwich structure includes a third polymer layer disposed on the core substantially opposite the second polymer layer.

In an embodiment, a composite sandwich structure is disclosed. The composite sandwich structure includes a thermoplastic layer having a high-temperature thermoplastic resin therein. The composite sandwich structure includes a first polymer layer disposed on the thermoplastic layer, the first polymer layer including sp² carbon-containing material therein. The composite sandwich structure includes a second polymer layer. The composite sandwich structure includes a core positioned between the first polymer layer and the second polymer layer, wherein the core includes a plurality of cells.

In an embodiment, a composite sandwich structure is disclosed. The composite sandwich structure includes a first polymer layer including sp² carbon-containing material therein. The composite sandwich structure includes a second polymer layer disposed on the first polymer layer. The composite sandwich structure includes a core positioned below the second polymer layer, wherein the core includes a plurality of cells. The composite sandwich structure includes a third polymer layer positioned below the core. The composite sandwich structure includes a fourth polymer layer including sp² carbon-containing material therein positioned below the third polymer layer.

In an embodiment, a method of making a composite is disclosed. The method includes forming a lay-up. The lay-up includes a first polymer layer having sp² carbon-containing material therein. The lay-up includes a second polymer layer disposed on the first polymer layer. The lay-up includes a core positioned on the second polymer layer, wherein the core includes a plurality of cells. The lay-up includes a third polymer layer disposed on the core substantially opposite the second polymer layer. The method includes pressing the lay-up in a mold. The method includes curing the lay-up to form a composite sandwich.

In an embodiment, a method of making a composite is disclosed. The method includes forming a lay-up. The lay-up includes a thermoplastic layer having a high-temperature thermoplastic resin therein. The lay-up includes a first polymer layer disposed on the thermoplastic layer, the first polymer layer including sp² carbon-containing material therein. The lay-up includes a second polymer layer. The lay-up includes a core positioned between the first polymer layer and the second polymer layer, wherein the core includes a plurality of cells. The method includes pressing the lay-up in a mold. The method includes curing the lay-up to form a composite sandwich.

In an embodiment, a method of making a composite is disclosed. The method includes forming a lay-up. The lay-up includes a first polymer layer including sp² carbon-containing material therein. The lay-up includes a second polymer layer disposed on the first polymer layer. The lay-up includes a core positioned below the second polymer layer, wherein the core includes a plurality of cells. The lay-up includes a third polymer layer positioned below the core. The lay-up includes a fourth polymer layer including sp² carbon-containing material therein positioned below the third polymer layer. The method includes pressing the lay-up in a mold. The method includes curing the lay-up to form a composite sandwich.

In an embodiment, a method of making a monolithic composite is disclosed. The method includes forming at least one polymer layer including a polymer resin, a plurality of fibers, and sp² carbon-containing material disposed therein. The method includes forming the at least one polymer layer into a selected shape. The method includes curing the at least one polymer layer.

In an embodiment, a monolithic composite is disclosed. The monolithic composite includes a plurality of fibers. The monolithic composite includes a polymer resin disposed on the plurality of fibers. The monolithic composite includes sp² carbon-containing material attached to the plurality of fibers or disposed on the polymer resin.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical or similar elements or features in different views or embodiments shown in the drawings.

FIG. 1 is an isometric view of a composite sandwich, according to an embodiment.

FIG. 2 is an isometric exploded view of the composite sandwich of FIG. 1, according to an embodiment.

FIG. 3 is a cross-sectional view of a composite sandwich, according to an embodiment.

FIG. 4 is a cross-sectional view of a composite sandwich, according to an embodiment.

FIG. 5 is a cross-sectional view of a composite sandwich, according to an embodiment.

FIG. 6 is a cross-sectional view of a monolithic composite, according to an embodiment.

FIG. 7 is an isometric view of a seatback, according to an embodiment.

FIG. 8 is a front view of a panel, according to an embodiment.

FIG. 9 is a flow chart of a method of making a composite sandwich structure, according to an embodiment.

FIG. 10 is a flow chart of a method of making a composite sandwich structure, according to an embodiment.

FIG. 11 is a flow chart of a method of making a composite sandwich structure, according to an embodiment.

FIG. 12 is a flow chart of a method of making a monolithic composite, according to an embodiment.

### DETAILED DESCRIPTION

Embodiments disclosed herein relate to composite structures containing a first polymer layer bonded to a second polymer layer. More specifically, embodiments relate to a first polymer layer including combinations of polymer resin and an sp² carbon-containing material (e.g., graphene sheets, graphene flakes, graphene nanoribbon, graphene spirals, patterned graphene, carbon nanotubes, fullerenes, other non-diamond carbon material, or combinations thereof), apparatus and methods for applying the polymer resin and sp² carbon-containing material to form fiber-reinforced composite sandwich structures, and fiber reinforced composite structures containing the polymer resins and the sp² carbon-containing material. In some examples, the sp² carbon-containing material may only include sp² carbon atoms. In some examples, the sp² carbon-containing material may include at least 90% sp² carbon atoms. Although the embodiments disclosed herein are described as employing sp² carbon-containing material such as graphene, carbon nanotubes, fullerenes, other non-diamond carbon, or combinations thereof, spa carbon-containing carbon allotropes such as diamond may be used as additional or alternative sources of carbon-containing materials for use in resin layers.

Moreover, many embodiments of polymer layers including sp² carbon-containing material disclosed herein have been found to result in a reduction in heat release—both peak and average heat release—of a composite structure relative to similar composite structures devoid of sp² carbon-containing material in a similarly positioned polymer layer. The inventor currently believes that the relatively high heat conductance of the sp² carbon-containing material in the polymer resins and composite laminate structures disclosed herein provides for heat absorption with a delayed transmittance of the absorbed heat most notably reducing the peak heat release. For example, as heat is absorbed into the sp² carbon-containing material, the heat is retained and primarily conducted therethrough in-plane (e.g., in the plane of a graphene sheet or axially along a carbon nanotube) and as such does not conduct or transmit out of the sp² carbon-containing material as quickly as in the case of a metal or pure resin layer, such as radially or perpendicularly to the plane of the sp² carbon containing material. Accordingly, at least the peak heat release of polymer layers having sp² carbon-containing material is lower than resin layers without the sp² carbon-containing material. Inclusion of sp² carbon-containing material in a polymer layer also can eliminate the necessity of a separate polymer layer interfacing the polymer layer in the composite structure or use of toxic phenolic materials to provide a heat release value that is suitable for use in automobile, boat, railcar, aircraft interiors, any other form of mass transportation, or other applications where controlling heat release is regulated or desired. Further, the polymer layers herein are stronger than phenolic resin composites and therefore may be thinner than phenolic composites.

The inventor has found that it is desirable to eliminate aluminum in composite laminate structures as a means of delayed or reduced heat release. Aluminum is used in composite laminates (as a continuous sheet or mesh) to lower the heat release of the composite laminate by conducting the heat away in the aluminum layer, compared to a composite laminate without the aluminum layer. However, aluminum in the composite laminate structure may cause defects, such as bubbles in the polymer layer or another polymer layer in contact therewith. For example, it is currently believed that aluminum reacts with the resins in contact with the aluminum layer during formation (e.g., molding, heating, or curing) of the composite laminate, which results in pinholes, voids, and other imperfections in the resin layers in contact therewith. The sp² carbon-containing resins, layers, and composite laminates disclosed herein solve the problem of costs, imperfections and weight created by adding the aluminum (or other metals) layer in a composite laminate structure all while lowering heat release to levels below safety and regulatory heat release standards.

It is desirable to produce light weight, strong, and stiff composites with relatively low heat release values (e.g., below 60 kW*min/m², below 40 kW*min/m², or below 30 kW*min/m²) for fabricating a structural component, such as a chassis; panels for communication equipment, frames, body parts, or interior components for transportation or vehicles (e.g., bicycles, motor cycles, boats, cars, trucks, trains, airplanes, other forms of mass transportation, etc.); agricultural applications (e.g., agricultural equipment), energy related applications (e.g., wind power, solar); satellite applications; aerospace applications (e.g., portions of a structure or an interior component of an aircraft such as a seat component or overhead bin); construction materials (e.g., building materials and the like); and consumer products (e.g., furniture, toilet seats, and electronic products among others). It is desirable to produce light weight, strong composite components with good energy absorption and heat release values where high bending stiffness, low weight, and low heat release are required by regulations or safety guidelines. The components may be designed to provide energy absorption, such as during a car, rail, aircraft, or other mass transportation accident. For safety reasons, the components may be designed to have some damping or energy absorption characteristics. At least some sp² carbon-containing material in the resin of one or more layers of a laminate composite component may provide increased strength to the component, such as an increase in tensile strength or bending stiffness compared to components formed with resin without the sp² carbon-containing material. For example, when a resin contains a minimal amount of single wall carbon nanotubes (e.g., 1 wt % to 4 wt %), the tensile strength of the resulting composite layer exhibits a significant increase in tensile strength (e.g., at least 5%, at least 10%, or at least 14% increase in tensile strength). The components formed with the resins or polymer-containing layers having sp² carbon-containing material therein may include a composite sandwich structure having high bending stiffness and low heat release as disclosed herein.

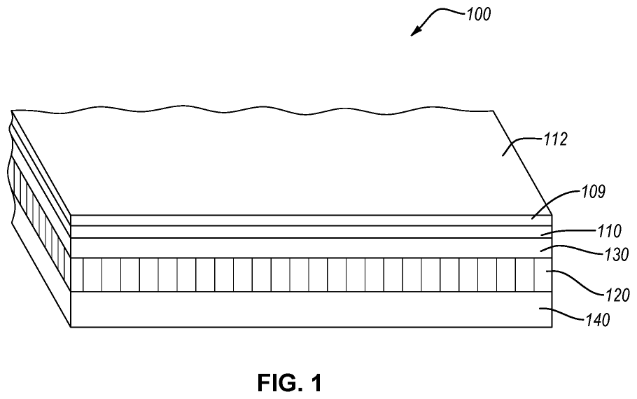

FIG. 1 is an isometric view of a composite sandwich 100, according to an embodiment. The composite sandwich 100 may include a layer or coating of paint 109, at least one polymer layer having the sp² carbon-containing material 110, a core 120, and at least one additional polymer layer 130 and/or 140. Additional polymer layer 140 may be a base layer in a composite stack. The core 120 may be disposed on the additional polymer layer 140. The additional polymer layer 130 may be positioned over the core 120. The polymer layer having the sp² carbon-containing material 110 may be positioned on the additional polymer layer 130 and the optional paint 109 may be disposed on the sp² carbon-containing material 110.

The at least one additional polymer layer 130 or 140, one or more polymer layers having the sp² carbon-containing material 110, and core 120 may be disposed in a laminate composite structure. In such examples, a polymer layer having the sp² carbon-containing material 110 may be directly bonded to the additional polymer layer 130. In many embodiments, an aluminum layer is not necessary in the laminate composite structure to meet heat release standards due to the enhanced heat release properties of the polymer layer having the sp² carbon-containing material 110. Accordingly, in some examples, a laminate composite structure includes one or more polymer layers having the sp² carbon-containing material 110 and one or more additional polymer layers disposed therein 130 or 140. In some examples, one or more optional, additional layers may be included in the laminate composite structure, such as one or more metal layers (e.g., aluminum layers or thermoplastic layers).

As shown, the paint 109 may be an outermost layer of the composite sandwich 100. Accordingly, the paint 109 may be at an outermost surface 112 of the composite sandwich 100. In some examples, a vinyl adhesive sticker may replace or be used in addition to the paint 109 to form the outermost surface 112 of the composite sandwich 100. The paint 109 may be disposed on the at least one polymer layer having the sp² carbon-containing material 110.

The at least one polymer layer having the sp² carbon-containing material 110 may be disposed beneath the layer or coating of paint 109. The at least one polymer layer having the sp² carbon-containing material 110 may include one or more of a polymer resin (in a cured or uncured state) having one or more polymer components therein, a fiber sheet, and sp² carbon-containing material. The polymer layer having the sp² carbon-containing material 110—or other polymer (e.g., thermoset resin-containing) layer(s) disclosed herein—may include a polymer resin mixture of one or more polymers having a relatively low viscosity and one or more polymers having a relatively high viscosity. For example, the polymer layer having the sp² carbon-containing material 110 may include a thermoset resin, such as a thermoset resin including a polyurethane and an epoxy. A polyurethane-containing polymer resin may provide one or more of a desired resistance to bending, resiliency, low viscosity, ability to bond to various materials, or a foaming capability (e.g., ability to form micro-foams during formation of composite laminate structures) to the polymer resin. An epoxy-containing polymer may provide a desired energy absorption or mechanical failure profile to the polymer resin, such as brittle breakage along a force vector parallel to the surface of the part. The epoxy-containing polymer may provide a water resistant (e.g., water tight) character to the resulting composite laminate or a better load transfer capability (e.g., a harder surface) than a high polyurethane content or polyurethane alone. In some examples, the polymer layer having the sp2 carbon-containing material may include a thermoplastic resin of predominantly thermoplastic components, such as high temperature thermoplastic resins.

The polymer (thermoset) resin may include a liquid blend or mixture of epoxy and polyurethane. In some examples, the polymer resin may include at most about 50% by volume of epoxy including a curing agent or hardener, up to about 20% by volume of a Group VIII metal material and the remaining volume may be polyurethane. When mixed, the epoxy may react (e.g., thermally and/or chemically) with the polyurethane. When the amount of epoxy exceeds a certain amount (e.g., about 40% by volume), an undesired reaction may occur, which may cause undesired heat and/or uncontrolled foaming In some examples, the polymer resin of the polymer layer(s) may include less than about 50% by volume of epoxy, such as about 40% by volume of epoxy, about 5% to about 40%, about 10% to about 35%, about 20% to about 30%, about 20% to about 40%, about 25% to about 35%, about 28% to about 32%, about 20%, about 25%, about 35%, or about 30% volume of the polymer resin. In some examples, the polymer resin may include less than about 30% by volume of epoxy. In some examples, the polymer resin may include less than about 20% by volume of epoxy. In some examples, the polymer resin may include less than about 10% by volume of epoxy. In some examples, the ratio of the polyurethane to the epoxy of the polymer resin may be about 1:1 or more, such as about 2:1, about 2.5:1, about 3:1, about 3.5:1, about 4:1, about 5:1, about 7:1, or about 9:1.

In some examples, the polymer resin may include more than about 50% by volume of epoxy, with the remainder including polyurethane. For example, the epoxy may be about 25% to about 75% (e.g., 50% to 75%) of the polymer resin by volume and the polyurethane may make up at least a portion of the balance of the polymer resin (e.g., 25% to 75%). In some examples, the polymer resin may include only epoxy, only polyurethane, or one of the foregoing in combination with additional resin material(s) (e.g., additional thermoset or thermoplastic).

In some examples, the polymer resin may include at least one curing agent or hardener, the hardener may be configured to cause one or more components of the polymer resin to cure. For example, when the polymer resin includes epoxy and polyurethane, the polymer resin may include a hardener for one or both of the epoxy or the polyurethane. Suitable hardeners for epoxies and polyurethanes may include any of those known to cure the epoxies and polyurethanes disclosed herein. For example, the at least one hardener may include amine-based hardeners for epoxies and polyisocyanate containing hardeners for polyurethanes. The curing agent or hardener may be present in the polymer resin in a ratio of about 1:100 to about 1:3 parts curing agent or hardener per part polymer resin or component thereof. In some embodiments, the hardener may be composed to start curing at about 50° C. or more, such as about 50° C. to about 150° C., about 70° C. to about 120° C., or about 70° C. to about 90° C., about 90° C. to about 110° C., or about 70° C. or more.

In some examples, the polymer resin may also include a blend of one or more thermosets and a thermoplastic, such as a mixture of one or more of epoxy, polyurethane, and thermoplastic. The thermoplastic may be included to provide a toughness or resiliency to the cured composite part. Suitable thermoplastics may include one or more of a polypropylene, a polycarbonate, polyethylene, polyphenylene sulfide, polyether ether ketone (PEEK) or another polyaryletherketone, or an acrylic. The thermoplastic may represent about 1% to about 20% of the polymer resin by volume. For example, the epoxy may be about 10% to about 35% of the polymer resin by volume, the thermoplastic may be about 1% to about 20% of the polymer resin by volume, and the polyurethane may make up the balance of the polymer resin. In an example, the epoxy may be about 25% to about 35% of the polymer resin by volume, the thermoplastic may be about 3% to about 15% of the polymer resin by volume, and the polyurethane may make up the balance of the polymer resin.

In some embodiments, the polyurethane or the epoxy may include one or more fire retardant components. For example, the polymer resin may include a phenolic epoxy or equivalents thereof.

The polymer mixture for the polymer layer(s) may have a relatively low viscosity (e.g., about 40 mPa·s or less) at room temperature. In some embodiments, the polymer resin may additionally include one or more of at least one hardener, at least one Group VIII metal material, at least one filler material, or at least one thermoplastic.

The polymer layers (e.g., polymer resins) disclosed herein may have relatively short cure times while exhibiting relatively little shrinkage (e.g., below about 3%). As used herein, the term “cure” or “cured” includes the meanings at least partially or fully cure or cured.

The polymer resin used in one or more polymer layers, such as the mixture of polyurethane and epoxy, may be water resistant after curing due to the properties of one or more of the materials therein. For example, when the amount of epoxy in a polyurethane/epoxy polymer resin is over about 28% by volume (e.g., 30% by volume), the polymer layer(s) may exhibit substantially water resistant character.

Furthermore, the polymer resin may enable formation of polyurethane micro-foams, which may enhance the bonding of the composite laminates to the core of the composite sandwich when such polymer resin containing layers (e.g., thermoset layers) are positioned in contact with the core 120. In some examples herein, a selected amount of foaming may be desired in the polymer resin of the polymer layer(s) such as by one or more components therein (e.g., the polyurethane reacting to form a micro-foam). As the polyurethane in the polymer resin foams, the foam (e.g., micro-foam) may infiltrate into adjacent components (e.g., fibers of adjacent layers or the cells or tubes of the core 120) thereby forming one or both of a chemical and mechanical bond with the adjacent components. Such infiltration may take place at the open ends of the core 120 and may include at least partial infiltration from the open ends inward. It was found that the composite laminates formed according the instant disclosure do not peel off the core 120, such as when the core 120 includes a plurality of plastic tubes. The polymer resin may similarly bond to adjacent polymer layers, such as by foaming or mixing of polymer resins in the adjacent layers.

The volume percentage or ratio of epoxy sufficient to cause an undesired or uncontrolled reaction (e.g., uncontrolled foaming) between the epoxy and polyurethane may vary with the addition of a Group VIII metal material to the resin. Group VIII metal materials may serve to stabilize or mediate the reaction of the epoxy and polyurethane in the polymer resin. The Group VIII metal material may include cobalt (Co), nickel (Ni), iron (Fe), ceramics (e.g., ferrites) including one or more of the same, or alloys including any of the same, among others. The Group VIII metal material may be equal to or less than 20% by volume of the polymer resin, such as about 0.1% to about 20%, about 0.5% to about 10%, about 1% to about 5%, about 2%, about 3%, less than about 4%, less than about 15%, less than about 10%, less than about 5%, or less than about 1% by volume of the polymer resin. By adding the Group VIII metal material to the polymer resin, the amount of epoxy therein may be increased to provide the surface hardness as desired and/or to create a substantially watertight surface. If watertight properties are desired in the final product, the polymer resin may include about 28% epoxy by volume or more, such as about 30% or more, about 30% to about 50%, about 32% to about 40%, or about 35% epoxy by volume.

In an example, the polymer (thermoset) resin may include polyurethane, epoxy, and at least one hardener. The at least one hardener may be composed to cause one or more components of the polymer resin to begin to cure. The at least one hardener may be specifically composed to cause only one component of the polymer resin to cure. Suitable hardeners may include amine-based hardeners for epoxies, polyisocyanate containing hardeners for polyurethanes, or any other hardener suitable to cause one or more components of the polymer resins disclosed herein to cure. In an example, the epoxy may be about 10% to about 35% of the polymer resin by volume, the at least one hardener may be present in a ratio of about 1:100 to about 1:3 of the polymer resin or component thereof (e.g., a 1:5 ratio of hardener to epoxy or hardener to resin) by volume, and the polyurethane may make up at least some of the balance of the polymer resin. The at least one hardener may be composed or used in an amount sufficient to cause the polymer resin to cure (e.g., at least partially harden) in a desired time, such as about 3 hours or less, about 2 hours or less, about 1 hour or less, about 30 minutes or less, about 20 minutes or less, about 15 minutes or less, or about 10 minutes or less, depending on required time to apply the polymer resin.

In some examples, one or more fillers may be added to the polymer resin mixture to reduce shrinkage during curing. Such fillers may include one or more of calcium carbonate, aluminum trihydroxide, alumina powders, silica powders, silicates, metal powders, or any relatively inert or insoluble (in the polymer resin) salt. In some examples, the filler may be about 30% of the volume of the polymer resin or less, such as about 1% to about 30%, about 2% to about 20%, about 5% to about 15%, about 10% to about 30%, about 1% to about 10%, more than zero percent to about 10%, about 1% to about 7%, about 3% to about 9%, less than about 10%, or about 25% of the volume of the polymer resin. In some examples, the filler may be about 10% of the volume of the polymer resin or more, such as about 50% or about 75%. Such fillers may allow faster curing times while reducing shrinkage, which typically occurs during fast cures. For example, the curing time of a polymer resin disclosed herein may be reduced to about 6 minutes or less, such as about 3 minutes or less, about 90 seconds or less, about 60 seconds, or about 40 seconds, while maintaining shrinkage of less than 3% by volume.

In some examples, the polymer layer(s) may include one or more thermoplastic components therein, such as in a minor amount (e.g., less than 50 wt % or vol %), so long as the polymer layer acts as a polymer. For example, the polymer layer having the sp² carbon-containing material (e.g., graphene-containing polymer resin) also may include one or more of polyetherimide (PEI), polyether ether ketone (PEEK), polytetrafluoroethylene (PTFE), perfluoroalkoxy (PFA), polyfluoroethylenepropylene (FEP), polyethylene terephthalate/polybutylene terephthalate (PET/PBT), other high temperature thermoplastics (e.g., thermoplastics with a melting point above 200° C.), or derivatives of any of the foregoing that have a melting point above 200° C. In some examples, the polymer layer having the sp² carbon-containing material 110 may include a relatively low heat release material, such as polypropylene, polycarbonate, polyethylene, etc. The thermoplastic may be provided in a liquid or solid form. For example, the thermoplastic may be a powder, crystals, grains, beads, pearls, sheets, sticks, a pre-impregnated fiber layer (e.g., pre-preg), etc., prior to being heated to a melting point. In some examples, the thermoplastic may be provided in liquid form, such as above a melting point of the thermoplastic or in a polymer solution or resin.

While specific examples of thermoset resin(s), a thermoplastic resin(s), mixtures thereof, or other polymer resins are described above for use in the polymer layer having the sp² carbon-containing material 110 or layers having the sp² carbon-containing material generally, it should be understood that any resin components and mixtures may be used to form layers having the sp² carbon-containing material therein. For example, a layer in a composite laminate may include a fiber sheet having a thermoplastic elastomer resin or silicone resin and sp² carbon-containing materials. Different polymer resins than those specifically named herein may be used to form a resin for a layer having the sp² carbon-containing material therein.

The polymer layer having the sp² carbon-containing material 110 may include a plurality of fibers holding or carrying any of the sp² carbon-containing material resins disclosed herein or combinations thereof. The plurality of fibers may include a fiber sheet, fiber mat, fiber fabric, fiber weave, a multi-ply fiber sheet, continuous fibers, aligned fibers, discontinuous fibers, etc. The fibers may be carbon fibers, glass fibers, thermoset fibers, or thermoplastic fibers, such as polyether ether ketone (PEEK), polyphenylene sulfide (PPS), aramid (e.g., meta-aramid or para-aramid), or the like. While generally costly compared to glass fibers, thermoplastic fibers may be desirable where stretching of the thermoplastic materials embedded in the polymer layer is desired during molding. Notably, glass and carbon fibers do not stretch during molding. In some examples, such resistance to stretching may be desired. In some examples, the plurality of fibers may include a glass fabric, polymer fabric, or carbon fiber fabric. The fabric may be a non-crimp fabric (NCF) or woven fabric. In some examples, the NCF may have a bi-axial configuration (e.g., fibers disposed at relative 0° and 90° angles). The bi-axial NCF has bi-directional strength and stiffness and flexible strength and stiffness. The NCF may provide greater pull out loads or tensile strength in highly loaded areas than the polymer resin alone. The NCF may also reduce print-through from a composite core. The fiber fabric may have one or more layers of fibers therein. In some examples, glass fibers may present an economical option for forming the polymer layer having the sp² carbon-containing material 110 than carbon fibers. Further, glass fibers may not deform (e.g., stretch or bend) as much as thermoplastic fibers when heated and pressed. For example, during a molding/curing process, plastic fibers in a composite laminate structure will stretch and bend far more than glass fibers.

In some examples, the plurality of fibers may be embedded in a polymer matrix (e.g., a polymer resin). In some examples, oriented or aligned continuous fibers may have a higher performance (e.g., higher bending stiffness) than the discontinuous fibers and may be cosmetically more appealing than the discontinuous fibers, such as woven fibers, but at a higher cost. A polymer layer having the sp² carbon-containing material including oriented continuous fibers may not stretch as much as a polymer layer having the sp² carbon-containing material including discontinuous fibers. The discontinuous fibers may be low cost recycled glass fibers, polymer fibers, or carbon fibers. For example, recycled carbon fibers that are waste from the resin transfer molding (RTM) or other sources may be used. For example, carbon fiber may be cut from dry NCF waste to a 35 mm fiber, and then formed into randomly oriented fiber sheet with an area density of at least about 200 g/m².

In some examples, the plurality of fibers in the polymer layer having the sp² carbon-containing material 110 may have a mass or weight of about 50 g/m² or more, 80 g/m² or more, 100 g/m² or more, such as about 150 g/m² to about 500 g/m², about 175 g/m² to about 350 g/m², about 200 g/m², about 300 g/m², or less than about 500 g/m². In some examples, the plurality of fibers may include an additional layer of fibers (e.g., NCF with mass or weight of about 300 g/m²) to further strengthen the composite. The additional layer of fibers may be separate from the first layer or may be embedded in the same polymer matrix as the first layer of fibers.

The polymer (e.g., thermoset) resin and sp² carbon-containing material may be applied to and/or embedded in the plurality of fibers by one or more of spraying or manually spreading (e.g., by trowel, roller, brush, or spatula). The polymer resin and sp² carbon-containing material may be pressed into the plurality of fibers, such as in a mold (e.g., a heat mold). In some examples, a resin and sp² carbon-containing material may be applied to the plurality of fibers as a solid (e.g., powder) and may subsequently be melted, such as in a mold, to infiltrate into the plurality of fibers. In some examples, the resin may be present in the plurality of fibers as a pre-preg fiber sheet or fabric. In such examples, more resin and sp² carbon-containing material may be added to the pre-preg, such as by spraying or spreading to provide a selected finish or resin content to the polymer layer.

The plurality of fibers may comprise at least 10 wt % of the polymer layer (e.g., thermoset layer) having the sp² carbon-containing material 110, such as 10 wt % to 90 wt %, 20 wt % to 80 wt %, 30 wt % to 70 wt %, 40 wt % to 60 wt %, 10 wt % to 30 wt %, 30 wt % to 60 wt %, 60 wt % to 90 wt %, 33 wt % to 66 wt %, 63 wt % to 80 wt %, less than 90 wt %, less than 70 wt %, less than 50 wt %, or less than 30 wt % of the polymer layer having the sp² carbon-containing material 110. The polymer resin may comprise at least 10 wt % of the polymer layer having the sp² carbon-containing material 110, such as 10 wt % to 90 wt %, 20 wt % to 80 wt %, 30 wt % to 70 wt %, 40 wt % to 60 wt %, 10 wt % to 30 wt %, 30 wt % to 60 wt %, 60 wt % to 90 wt %, less than 90 wt %, less than 70 wt %, less than 50 wt %, or less than 30 wt % of the polymer layer having the sp² carbon-containing material 110. In some examples, it may be desirable to use less than about 33 wt % resin in the polymer layer having the sp² carbon-containing material 110, with the remainder comprising fibers such as glass fibers. In such examples, the heat release of a composite sandwich structure containing less than about 33 wt % resin in the outer layer, may be very low (e.g., below 30 kW*Min./m²).

The sp² carbon-containing material of the polymer layer having an sp² carbon-containing material 110 may include graphene sheets, graphene flakes, carbon nanotubes (e.g., single wall or multiwall carbon nanotubes), graphene nanoribbon, graphene spirals, patterned graphene (e.g., a graphene spring), other tube-like graphene structures, fullerenes, other non-diamond carbon, or combinations thereof. The sp² carbon-containing material may be provided or present in a resin, such as thermoset resin including one or more thermoset components. For example, the polymer layer may include graphene sheets or spirals, single-wall nanotubes, multi-wall nanotubes, etc., in a powder mixed in a thermoset resin, attached to the plurality of fibers, or a combination thereof. In some examples, the polymer resin having an sp² carbon-containing material may be disposed on or impregnated in a plurality of fibers, such as a glass fabric or carbon fiber weave to form the polymer layer having sp² carbon-containing material therein. In some examples, the polymer resin having an sp² carbon-containing material therein may constitute the entire polymer layer (e.g., no plurality of fibers in the layer).

In some examples, the polymer layer having an sp² carbon-containing material 110 may include sp² carbon-containing material distributed substantially uniformly throughout the polymer resin therein. In some examples, the polymer layer having an sp² carbon-containing material may include sp² carbon-containing material distributed unevenly throughout the polymer resin therein. For example, the polymer layer having an sp² carbon-containing material may include sp² carbon-containing material distributed more heavily in an outer portion of the polymer layer relative to a center portion of the polymer layer, such as where the sp² carbon-containing material is selectively positioned on an outermost portion of the polymer layer or a fiber sheet is coated in the polymer resin having the sp² carbon-containing material to form the polymer layer having the sp² carbon-containing material.

In some examples, the sp² carbon-containing material may be selectively positioned throughout one or more portions of a polymer layer or a fiber sheet. For example, and as discussed in more detail below the sp² carbon-containing material may be grown on fibers of a fiber sheet (e.g., glass fibers or carbon fibers). In examples where the sp² carbon-containing material is attached to the plurality of fibers (e.g. , glass fiber fabric), the resin applied thereto may delaminate from the plurality of fibers under high temperatures. In such examples, the difference in heat release values between the resin and the sp² carbon-containing material disposed on the plurality of fibers (e.g., the delayed peak heat release) may cause delamination of the cured resin from the plurality of fibers and the sp² carbon-containing material. Such delamination may be desirable as it would allow extinguishment of burning resins.

The sp² carbon-containing material may comprise at least 2 wt % of the mass of the polymer resin applied per square meter of fiber, such as 2 wt % to 4 wt %, 2 wt % to 6 wt %, 2 wt % to 8 wt %, 2 wt % to 10 wt %, 2 wt % to 15 wt %, 2 wt % to 20 wt %, 2 wt % to 30 wt %, 2 wt % to 40 wt %, 2 wt % to 50 wt %, 2 wt % to 75 wt %, 2 wt % to 90 wt %, 4 wt % to 6 wt %, 4 wt % to 8 wt %, 4 wt % to 10 wt %, 4 wt % to 15 wt %, 4 wt % to 20 wt %, 4 wt % to 30 wt %, 4 wt % to 40 wt %, 4 wt % to 50 wt %, 4 wt % to 75 wt %, 4 wt % to 90 wt %, 6 wt % to 8 wt %, 6 wt % to 10 wt %, 6 wt % to 15 wt %, 6 wt % to 20 wt %, 6 wt % to 30 wt %, 6 wt % to 40 wt %, 6 wt % to 50 wt %, 6 wt % to 75 wt %, 6 wt % to 90 wt %, 8 wt % to 10 wt %, 8 wt % to 15 wt %, 8 wt % to 20 wt %, 8 wt % to 30 wt %, 8 wt % to 40 wt %, 8 wt % to 50 wt %, 8 wt % to 75 wt %, 8 wt % to 90 wt %, 10 wt % to 15 wt %, 10 wt % to 20 wt %, 10 wt % to 30 wt %, 10 wt % to 40 wt %, 10 wt % to 50 wt %, 10 wt % to 75 wt %, 10 wt % to 90 wt %, less than 90 wt %, less than 75 wt %, less than 50 wt %, less than 40 wt %, less than 30 wt %, less than 20 wt %, less than 15 wt %, less than 10 wt %, less than 8 wt %, less than 6 wt %, less than 5 wt %, or less than 4 wt % of the mass of resin applied per square meter of fiber. The sp² carbon-containing material may be present in the polymer resin of a polymer layer in a substantially uniform distribution throughout the volume of the polymer resin.

The sp² carbon-containing material may be at least 2 wt % of the any of the individual polymer layer(s) disclosed herein, such as 2 wt % to 4 wt %, 2 wt % to 6 wt %, 2 wt % to 8 wt %, 2 wt % to 10 wt %, 2 wt % to 15 wt %, 2 wt % to 20 wt %, 2 wt % to 30 wt %, 2 wt % to 40 wt %, 2 wt % to 50 wt %, 2 wt % to 75 wt %, 2 wt % to 90 wt %, 4 wt % to 6 wt %, 4 wt % to 8 wt %, 4 wt % to 10 wt %, 4 wt % to 15 wt %, 4 wt % to 20 wt %, 4 wt % to 30 wt %, 4 wt % to 40 wt %, 4 wt % to 50 wt %, 4 wt % to 75 wt %, 4 wt % to 90 wt %, 6 wt % to 8 wt %, 6 wt % to 10 wt %, 6 wt % to 15 wt %, 6 wt % to 20 wt %, 6 wt % to 30 wt %, 6 wt % to 40 wt %, 6 wt % to 50 wt %, 6 wt % to 75 wt %, 6 wt % to 90 wt %, 8 wt % to 10 wt %, 8 wt % to 15 wt %, 8 wt % to 20 wt %, 8 wt % to 30 wt %, 8 wt % to 40 wt %, 8 wt % to 50 wt %, 8 wt % to 75 wt %, 8 wt % to 90 wt %, 10 wt % to 15 wt %, 10 wt % to 20 wt %, 10 wt % to 30 wt %, 10 wt % to 40 wt %, 10 wt % to 50 wt %, 10 wt % to 75 wt %, 10 wt % to 90 wt %, less than 90 wt %, less than 75 wt %, less than 50 wt %, less than 40 wt %, less than 30 wt %, less than 20 wt %, less than 15 wt %, less than 10 wt %, less than 8 wt %, less than 6 wt %, less than 5 wt %, or less than 4 wt % of the polymer layer.

The polymer layer having an sp² carbon-containing material 110 provides structural strength and flame retardant properties to composite laminate structures sufficient to meet heat release standards for aerospace applications without utilizing phenolic resins or aluminum layers.

The polymer layer having an sp² carbon-containing material 110 (e.g., first polymer layer) may be disposed nearest the outermost surface 112 of the composite sandwich 100. The composite sandwich 100 may include one or more of the additional polymer layers 130 or 140 (e.g., second and third polymer layers). For example, the polymer layer having an sp² carbon-containing material 110 may be disposed over the core 120. In such embodiments, the additional polymer layer 130 may be disposed between the polymer layer having an sp² carbon-containing material 110 and the core 120. Additional polymer layer 140 may be disposed below the core 120, as shown.

In some examples, the additional polymer layers 130 and/or 140 may be similar or identical to the polymer layer having an sp² carbon-containing material 110 in one or more aspects. For example, the polymer layer(s) 130 or 140 may include one or more of any of the polymer resins (e.g., thermoset resin, thermoplastic resin, or mixture thereof), pluralities of fibers, types of fibers, fiber weights, sp² carbon-containing material, hardeners, catalysts, fillers, or the like disclosed herein for the polymer layer having an sp² carbon-containing material 110. The polymer layer(s) 130 or 140 may include any of the dimensions or characteristics of the polymer layer having the sp² carbon-containing material disclosed herein for the polymer layer having an sp² carbon-containing material 110. In some examples, the additional polymer layer 130 (e.g., second polymer layer) may be similar or identical to the additional polymer layer 140 (e.g., third polymer layer) in one or more aspects. In some examples, the additional polymer layer 130 may differ from the additional polymer layer 140 in one or more aspects. For example, one or more of a polymer (e.g., thermoset) resin, amount of polymer resin in the polymer layer, layer thickness, fiber type, fiber weight, lateral dimensions, sp² carbon-containing material amount, etc., of the additional polymer layer 130 may differ from the same aspects of the additional polymer layer 140.

One or more of the additional polymer layer(s) 130 and 140 may include any of the plurality of fibers or forms thereof disclosed herein. In some examples, the plurality of fibers in the polymer layer having the sp² carbon-containing material 110 may be similar or identical to the plurality of fibers in any additional polymer layer(s) 130 or 140, in one or more aspects. For example, the plurality of fibers in at least one additional polymer layer 130 or 140 and the plurality of fibers in the polymer layer having the sp² carbon-containing material 110 may include glass fibers. In some examples, the plurality of fibers in the additional polymer layer(s) 130 or 140 may differ from the plurality of fibers in the polymer layer having the sp² carbon-containing material 110, in one or more aspects. For example, the plurality of fibers in at least one additional polymer layer 130 may include glass, carbon, thermoset, or thermoplastic fibers, the plurality of fibers in at least one additional polymer layer 140 may include glass, carbon, thermoset, or thermoplastic carbon fibers, and the plurality of fibers in the polymer layer having the sp² carbon-containing material 110 may include fibers other than the fibers used in one or more of the additional polymer layers 130 and 140.

The plurality of fibers may comprise at least 10 wt % of any individual polymer layer(s) disclosed herein, such as 10 wt % to 90 wt %, 20 wt % to 80 wt %, 30 wt % to 70 wt %, 40 wt % to 60 wt %, 10 wt % to 30 wt %, 30 wt % to 60 wt %, 60 wt % to 90 wt %, 33 wt % to 66 wt %, 63 wt % to 80 wt %, less than 90 wt %, less than 70 wt %, less than 50 wt %, or less than 30 wt % of the polymer layer(s). The polymer resin may comprise at least 10 wt % of any individual polymer layer(s) disclosed herein, such as 10 wt % to 90 wt %, 20 wt % to 80 wt %, 30 wt % to 70 wt %, 40 wt % to 60 wt %, 10 wt % to 30 wt %, 30 wt % to 60 wt %, 60 wt % to 90 wt %, less than 90 wt %, less than 70 wt %, less than 50 wt %, or less than 30 wt % of the polymer layer(s).

In some examples, one or more of the additional polymer layers 130 or 140 may differ from the polymer layer having the sp² carbon-containing material 110 in one or more aspects, such as in one or more of material composition (e.g., polymer resin formulation or amount), thickness, fiber weight or type, or any other aspect. For example, one or more of the additional polymer layer(s) 130 or 140 may not have sp² carbon-containing material disposed therein, may include a different polymer resin from the polymer resin used in the polymer layer having the sp² carbon-containing material 110, or may be thicker than the polymer layer having the sp² carbon-containing material 110. In some examples, the additional polymer layer 130 or the additional polymer layer 140 may independently include a thermoset resin, a thermoplastic resin, or a mixture thereof that differs from the polymer resin used in one or more of the polymer layer having the sp² carbon-containing material 110 or the other of the additional polymer layer 130 or the additional polymer layer 140, in one or more aspects. For example, the additional polymer layer 140 may include a thermoplastic resin, while one or more of the additional polymer layer 130 or the polymer layer having the sp² carbon-containing material 110 may include thermoset resin.

In some examples, the additional polymer layer 130 may include a thermoset resin (e.g., epoxy-polyurethane mixture) and a 220 g/m² glass fiber sheet. The additional polymer layer 130 may be disposed on the core 120 and bond to the core 120 via the polymer resin. For example, the thermoset resin in the additional polymer layer 130 may foam (e.g., form a micro-foam) under process conditions and the foam may at least partially infiltrate into the core 120. Upon hardening (e.g., curing) the thermoset resin serves to bond the core 120 to the additional polymer layer 130.

In some examples, the at least one polymer layer having the sp² carbon-containing material 110 may be an outermost layer of the composite sandwich 100. The polymer layer having the sp² carbon-containing material 110 may be bound to the additional polymer layer 130. For example, the polyurethane in the polymer resin of the additional polymer layer 130 may bond to the resin of the polymer layer having the sp² carbon-containing material 110. In some examples, the polymer layer having the sp² carbon-containing material 110 may be abraded prior to bonding to provide a roughed surface for bonding to the as-yet uncured additional polymer layer 130, or vice versa. In some examples, the texture of the outermost surface 112 may be selectively formed to provide a desired appearance, such as a smooth appearance, a roughened appearance, a leather appearance, or any other textured appearance such as by controlling the texture of the polymer layer having the sp² carbon-containing material 110.

The additional (second) polymer layer 130 can be bonded directly to the (first) polymer layer having the sp² carbon-containing material 110, such as in coplanar or parallel orientation to the polymer layer having the sp² carbon-containing material 110. In some examples, the lateral dimensions of the polymer layer having the sp² carbon-containing material 110 may be coextensive with one or more of the additional polymer layers 130 or 140. In some examples, the lateral dimensions of polymer layer having the sp² carbon-containing material 110 may be larger than—extend past the largest extent of—one or more of the additional polymer layers 130 or 140.

As shown in FIG. 1, the at least one additional polymer layer 130 (e.g., second polymer layer) may be disposed on the core 120. The core 120 may be bound to the additional polymer layer 130 by the polymer resin, such as by the thermoset resin from the polymer layer foaming and at least partially infiltrating into the core 120. The core 120 may include one or more of a “soft” core or a “hard” core material. The “hard” core may effectively transfer the load from one end (e.g., side) of the core to the other end of the core. For example, the “hard” core may be formed from a core blank that includes one or more plastic materials and may include a plurality of cells having open ends (e.g., closely-packed substantially parallel plastic tubes). The plurality of cells may be at least partially defined by corresponding one or more cell walls (e.g., the plastic material may define a honeycomb or honeycomb-like structure, where the cells may have any number of suitable shapes). In some embodiments, the compressible cells of the core blank may be formed or defined by tubes or straws. In some embodiments, the cells may be tubes, such as drinking straws (e.g., each straw may define a corresponding cell of the core and adjacent cores may define additional cells in the gaps or spaces therebetween). The cells may be formed from polycarbonate, polyethylene, polypropylene, polyphenylene sulfide (PPS), polyether ether ketone (PEEK), PEI, or other thermoplastics. Thermoplastic straws may be commercially made of polycarbonate at very low cost and may be secured together in a generally parallel arrangement. The use of polycarbonate, polyethylene, polypropylene, polyether ether ketone (PEEK), PEI, or other plastics in the core 120 may provide a greater resistance to tearing upon application of tension to the core 120 than is found in cardboard or paper board core materials. In some examples, a honeycomb-like structure may be provided by a plurality of non-cylindrical cells formed from non-cylindrical tubes. In some examples, the core 120 may include a unitary structure including a plurality of co-extruded thermoplastic tubes sharing common walls. The core may include more than one type or shape of cells in the plurality of cells. The core 120 of the composite sandwich may include a bundle of PEI plastic tubes, and may be suitable for fabricating auto components, such as a chassis dashboard; seat components, such as a seat back; structural components, such as a bulkhead or overhead bins, etc.

The hard core may alternatively or additionally include a foam, such as a closed cell foam. The foam may be a high density foam or a low density foam. The foam may be a foam body, such as a block, sheet, or other body of foam. The foam may be made from a polymer such as any of the thermosets or thermoplastics disclosed herein or any other suitable polymer. For example, the foam may include a polyurethane foam, a polycarbonate foam, a polymethacrylimide (PMI)-based foam. The foam of the foam body may be an open-cell or closed-cell foam. In some examples, sp² carbon-containing material may be disposed in the material of the foam core. For example, graphene flakes or another sp² carbon-containing material may be incorporated in the polymer material of the foam core. In such examples, the amount of sp² carbon-containing material in the foam core may be similar or identical to any of the amounts of sp² carbon-containing material disposed in the polymer resin of the polymer layer having the sp² carbon-containing material disposed herein. In examples utilizing foam cores, the polymer resin (e.g., a thermoset micro-foam formed therefrom) may bond the foam body core to the additional polymer layer 130, such as via the polyurethane or the infiltration into cells of the foam body. In some examples, the foam (e.g., foam body) may be present as a separate layer adjacent to the plurality of cells. In some examples, the foam may be present at least partially within at least some the plurality of cells, such as by compression into the plurality of cells. The hard core can provide a high bending stiffness for the composite sandwich. The “hard” core may increase the bending stiffness of the composite sandwich more than the “soft” core.

The “hard” core, such as that formed of open ended plastic cells, such as tubes or drinking straws, may be difficult to attach to the composite laminate (e.g., one or more thermoset and/or thermoplastic layers over the core) using a conventional epoxy. For example, the composite laminate may be more likely to peel off the “hard” core when a conventional epoxy is used. The polymer resins according to examples disclosed herein resolve the peeling problem for the composite sandwich that includes a “hard” core by providing sufficient adhesion thereto (e.g., by greater adhesion with micro-foams formed by the polyurethane/epoxy blend which may at least partially extend into the cells via the open ends).

In contrast, a “soft” core may not transfer the load from one end of the core to the opposite end of the core when a load is applied onto one end of the core, for example, the “soft” core may be formed from paperboards, or cardboards, or low density foams, and the like. The “soft” core may absorb more energy or impact vertically than the “hard” core (e.g., in a direction substantially perpendicular to the plane of the composite laminates) assuming the impact is along a Z axis (e.g., generally perpendicular to the outermost surface 112 of the composite sandwich 100). The “hard” core may absorb more energy horizontally, such as along the plane of the composite laminates (e.g., in an X-Y plane) which is perpendicular to the Z axis. The composite sandwich, including paperboards, may be used for car hoods, automotive surface panels (e.g., A-class surface panels having minimal pinholes or porosity therein), aerospace applications, consumer products (e.g., furniture), or construction materials or similar applications where energy absorption is desired. The “soft” core does not transfer a load having a vector substantially perpendicular to the core as well as the “hard” core does.

In some examples (not shown), the core 120 may include both soft and hard core materials, such as in adjacent layers. For example, a composite sandwich may include a plurality of cells and a paperboard running parallel thereto. In such examples, the paperboard may provide sound dampening and the hard core may absorb more energy than the paperboard.

In some examples, the core 120 may have a density of about 20 kg/m³ or more such as about 20 kg/m³ to about 150 kg/m³, about 40 kg/m³ to about 100 kg/m³, about 60 kg/m³ to about 80 kg/m³, or about 65 kg/m³ to about 75 kg/m³. The core 120 may have an initial cell height (e.g., core thickness) of about 100 μm to about 10 cm, about 1 mm to about 5 cm, about 5 mm to about 3 cm, about 250 μm to about 1 cm, about 1 cm to about 5 cm, about 1 mm to about 5 mm, about 2 mm to about 6 mm, about 5 mm to about 1 cm, about 7 mm, about 4 mm, about 2 mm, or about 1 cm. In some examples, the core 120 may have a density of about 70 kg/m³ and a cell height of about 7 mm. Depending on the material of the core 120, it may be desirable to limit the cell height to limit the heat release of the composite sandwich. The cells of the core 120 may include a plurality of integrally formed tubes (e.g., a plurality of open-ended structures bound together in parallel), which may collectively bend or otherwise distort in one or more regions upon application of, tension, heat, and/or pressure in a mold, whereas cardboard may tear under the same conditions. In some embodiments, the core 120 may bend, compress, or stretch in one or more regions therein, depending on the geometry of the mold and desired finished dimension of a part including the same. The cells or tubes may be bonded together such as by integral formation (e.g., extruded or molded together), an adhesive, thermal bonding (e.g., melting) such as being bonded together after being individually extruded, or any other suitable attachment means. The cells or tubes may be composed to at least partially soften or melt upon application of a specific amount of heat. For example, the cells or tubes may be composed to soften or melt and at least partially compress, while in a mold such that the resulting composite sandwich may at least partially comply with the shape of a mold. The length of each of the tubes prior to compression may be selected to provide a desired amount of compliance upon application of heat and/or pressure thereto. For example, the length or height of compressed or uncompressed tubes may be about 100 μm to about 10 cm, about 1 mm to about 5 cm, about 5 mm to about 3 cm, about 250 μm to about 1 cm, about 1 cm to about 5 cm, about 1 mm to about 5 mm, about 2 mm to about 6 mm, about 5 mm to about 1 cm, about 7 mm, about 4 mm, about 2 mm, or about 1 cm. The tubes may exhibit a substantially similar height and/or diameter. For example, the tubes may exhibit a diameter of about 1 mm or more, such as about 1 mm to about 5 cm, about 3 mm to about 3 cm, about 5 mm, to about 1 cm, about 6 mm, less than about 2 cm, or less than about 1 cm. While the cells (e.g., tubes) depicted herein have a circular cross-sectional shape, the cells may exhibit substantially polygonal cross-sectional shapes (e.g., triangular, rectangular, pentagonal, etc.), elliptical cross-sectional shapes, or amorphous shapes (e.g., having no set pattern or being a combination of circular and polygonal), when viewed along the longitudinal axis thereof. The cells may be defined by a single integral structure with common walls between adjacent cells or tubes. While the term “cells” or “tubes” is used herein, in some embodiments the cells or tubes may include on one or more closed ends; or exhibit configurations other than tubular (e.g., circular), such as polygonal (e.g., a plurality of closed or open pentagonal cells), or configurations not having connected sides therebetween (e.g., baffles).

In some embodiments, the core 120 may be fully compressed to form a solid or may be partially compressed to reduce the core height. The compressed core height may be about 15% or more of the initial core height, such as about 15% to about 90%, about 25% to about 75%, about 40% to about 60%, about 15% to about 50%, or about 15% of the initial core height. It will be appreciated that the number of layers may vary above and below the core 120 of the composite sandwich, such as having different layers or materials therein. The dimension and density of the core 120 may vary, such as having more cells (e.g., tubes) in one or more regions thereof, having larger or smaller diameter cells in one or more regions thereof than in adjacent regions, having one or more regions including tubes having different (e.g., smaller or larger) wall thicknesses than tubes in adjacent regions, or combinations of any of the foregoing. The weight of the fiber sheet or NCF may vary in one or more regions of the composite sandwich.

At least one additional polymer layer, such as additional polymer layer 140 (e.g., third polymer layer) may be disposed below the core 120. The at least one additional polymer layer 140 may include a plurality of fibers identical to or different from the fibers in one or more of the polymer layer having the sp² carbon-containing material 110 and the at least one additional polymer layer 130 (e.g., second polymer layer). For example, the polymer layer having the sp² carbon-containing material 110 may include glass fibers, the at least one additional polymer layer 130 may include glass fibers, and the at least one additional polymer layer 140 may include glass or carbon fibers. In some examples, the polymer layer having the sp² carbon-containing material 110 may include a mixture of polyurethane, epoxy resin, and sp² carbon-containing material embedded in a plurality of glass fibers, the at least one additional polymer layer 130 may include a polyurethane and epoxy resin embedded in a second plurality of glass fibers, and the at least one additional polymer layer 140 may include a polyurethane and epoxy resin embedded in a plurality of carbon fibers.

Any of the polymer layer(s) 110, 130, or 140 may have a thickness greater than about 0.01 mm, such as 0.01 mm to 1 cm, 0.1 mm to 1 cm, 0.01 mm to 5 mm, 0.1 mm to 5 mm, 0.1 mm to 1 mm, 0.05 mm to 0.5 mm 0.05 mm to 0.3 mm, 0.3 mm to 0.6 mm, 0.5 mm to 7 mm, 0.6 mm to 1 mm, 1 mm to 3 mm, 2 mm to 5 mm, at least 0.1 mm, at least 0.5 mm, at least 1 mm, at least 2 mm, at least 3 mm, at least 5 mm, less than 2 cm, less than 1 cm, less than 5 mm, less than 2 mm, or less than 1 mm. In some examples, the thickness of the polymer layer(s) 110, 130, and 140 may be identical. In some examples, the thicknesses of the polymer layer(s) 110, 130, and 140 may differ from each other. In some examples, additional polymer layer(s) 130 and/or 140 may have a thickness that is at least 2 times the thickness of the polymer layer having the sp² carbon-containing material 110, such as at least 3 times, at least 5 times, or at least 10 times the thickness of the polymer layer having sp² carbon-containing material 110. In some examples, the one or more of the polymer layer(s) 110, 130, or 140 may not have a uniform thickness throughout the entire lateral extents of the layer(s).

In some examples, the polymer layer having the sp² carbon-containing material 110 or additional polymer layers 130 or 140 may also include a colorant such as a pigment or dye to provide a selected color to the respective polymer layer(s).

In some examples, at least one of the polymer layer(s) may be provided as a pre-molded body. In such examples, one or more of the polymer layer having the sp² carbon-containing material 110 or one or more additional polymer layers 130 or 140 may more readily fill the corners of a mold. In some examples, the at least one polymer layer may be provided as a pre-preg or may be formed by applying the polymer resin (e.g., containing graphene tubes or spirals) onto a fiber sheet or other fiber mass.

In some examples, one or more additional layers (not shown) may be disposed between any of the components of the composite sandwich 100. It may be desirable to lower a heat release value for a composite laminate even further than the polymer layer having the sp² carbon-containing material 110 or an aluminum layer alone can provide. In such examples, one or more metal layers and one or more polymer layers having the sp² carbon-containing material may be utilized. For example, a metal layer, such as an aluminum layer may be disposed between the polymer layer having the sp² carbon-containing material 110 and the at least one additional polymer layer 130. In such examples, the metal layer may be at least about 0.01 mm thick, such as at least about 0.1 mm thick (e.g., about 0.2 mm). While the metal layer may be used, the metal layer is not necessary to achieve satisfactory heat release characteristics where a polymer layer having sp² carbon-containing material 110 therein is used. For example, the heat release characteristics of a composite laminate component having a polymer layer having the sp² carbon-containing material 110 disposed over an additional polymer layer 130, core 120, and further additional polymer layer 140 may be well within safety standards for heat release in automotive, aircraft, marine, rail, etc., applications (e.g., less than 65 kW*min/m², less than 40 kW*min/m², or less than 30 kW*min/m²).

In some examples, a soft core material (e.g., cardboard) may be disposed between the core 120 and the at least one additional polymer layer 130 and/or 140. In some examples, the composite sandwich 100 may include a thermoplastic layer, such as a thermoplastic layer disposed on the polymer layer having the sp² carbon-containing material 110 or below the at least one additional polymer layer 140. The thermoplastic layer may include any of the thermoplastic components disclosed therein and be similar or identical to any of the polymer layers disclosed herein in one or more aspects (e.g., dimensions). In some embodiments, the at least one thermoplastic layer may include a PEI thermoplastic layer disposed over the polymer layer having the sp² carbon-containing material 110.

The inventor has found that the positioning and orientation of the sp² carbon-containing material in the polymer layer having the sp² carbon-containing material 110 (or additional polymer layers 130 or 140) effects the heat release of the composite laminate structure formed with the same.

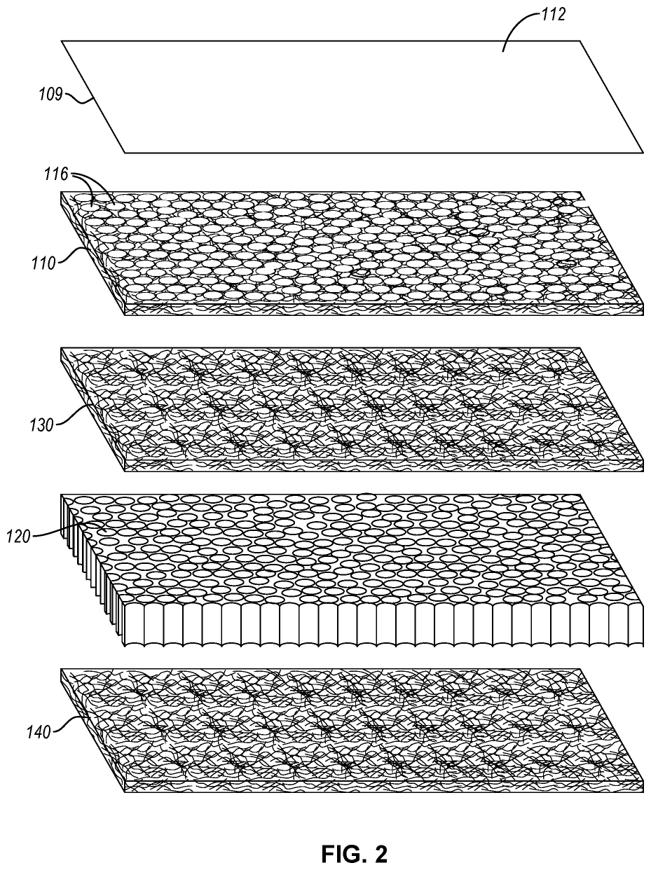

FIG. 2 is an isometric exploded view of the composite sandwich 100 of FIG. 1, according to an embodiment. As shown in FIG. 2, one or more of the position or orientation of the sp² carbon-containing material 116 of the polymer layer having the sp² carbon-containing material 110 may selectively controlled. For example, a plurality of carbon nanotubes or graphene flakes in the polymer layer or on the plurality of fibers may be oriented in a direction parallel, perpendicular, or obliquely to the plane or major axis of the polymer layer having the sp² carbon-containing material 110. As shown in FIG. 2, the sp² carbon-containing material 116 may include plurality of graphene flakes in the polymer layer or on the plurality of fibers of the polymer layer having the sp² carbon-containing material 110. For example, the graphene flakes may be oriented in a direction parallel to the major axis (e.g., parallel to the plane) of the polymer layer having the graphene flakes or the plurality of fibers therein. The inventor has found that when the sp² carbon-containing material 116 is oriented in a parallel planar configuration with the plane of the polymer layer having the sp² carbon-containing material therein 110, such as when the major axis of the sp² carbon-containing material 116 is parallel to the major axis of the composite sandwich 100 or the outermost surface 112 thereof (such as when the composite laminate structure is non-planar), the heat release value of the composite sandwich 100 is even lower than examples where the sp² carbon-containing material 116 is otherwise oriented (e.g., randomly or perpendicular to the outer surface of the composite sandwich).

In some examples, the sp² carbon-containing material may be applied or affixed to the plurality of fibers prior to addition of a resin thereto. For example, carbon nanotubes, graphene sheets, graphene flakes, or the like may be deposited or even grown on the plurality of fibers prior to application of a polymer (e.g., thermoset) resin thereto, such as on a selected side of a fiber sheet. In some examples, seed material and/or catalysts may be applied to the plurality of fibers to form the sp² carbon-containing material thereon. For example, a Group VIII metal such as cobalt may be disposed on (e.g., bound to) at least some of the plurality of fibers and the cobalt may serve to catalyze formation of sp² carbon-containing material (e.g., carbon nanotubes, graphene sheets, or graphene flakes) on the fibers in a chemical vapor deposition process. In such examples, the Group VIII metal in the sp² carbon-containing material may be used to at least partially orient at least some of the sp² carbon-containing material in a selected direction, such as by exposing the sp² carbon-containing material having the Group VIII metal to a magnetic field oriented in the selected direction. Other processes may be used to attach or grow sp² carbon-containing material on the plurality of fibers, such as adhesion of preformed materials onto the plurality of fibers, laser formation techniques, etc.

In some examples, the sp² carbon-containing material may be applied to the plurality of fibers in a pre-preg, where the resin in the pre-preg or an additional adhesive adheres the sp² carbon-containing material to the plurality of fibers. In such examples, polymer resin (e.g., thermoset and/or thermoplastic resin) may be applied to the sp² carbon-containing material disposed on the fibers in the pre-preg. The sp² carbon-containing material may be disposed on the plurality of fibers as a layer of material thereon. The resin may be applied on the layer of sp² carbon-containing material thereafter.

The sp² carbon-containing material may be selectively positioned throughout one or more portions of the polymer layer or the fiber sheet therein. For example, the sp² carbon-containing material may be grown on fibers of the fiber sheet (e.g., glass fibers or carbon fibers). Seed material such as cobalt, nickel, ruthenium, or the like may be selectively positioned on the fiber sheet and sp² carbon-containing material (e.g., graphene sheets or flakes) may be grown on the seed material in-situ, such as via chemical vapor deposition. Accordingly, the resulting sp² carbon-containing material may be positioned on the fiber sheet in a selected distribution (e.g., one or more of a density, pattern, or orientation) as controlled by the seed material and the deposition process. By affixing the sp² carbon-containing material to the fiber sheet, the distribution of the sp² carbon-containing material may be maintained as opposed to embodiments where the sp² carbon-containing material is mixed with the polymer resin where some discontinuities or other non-uniform distributions of sp² carbon-containing material may be present. Such control of the sp² carbon-containing material distribution provides more predictable heat release results compared to composite materials containing the sp² carbon-containing material layer in randomly oriented distributions.

Further, the inventor has found that by locating the sp² carbon-containing material 116 nearer the outermost surface 112, the heat release of a composite sandwich structure can be lowered compared to examples where the sp² carbon-containing material 116 is located farther from the outermost surface 112. Accordingly, in some embodiments the sp² carbon-containing material 116 may be positioned or affixed to an outermost side (e.g., the side intended to face a possible heat source) of the polymer layer having the sp² carbon-containing material 110, the outermost side of the plurality of fibers therein, or an outermost side of any other layer of the composite sandwich 100. While the sp² carbon-containing material 116 in FIG. 2 is depicted on the outermost side (e.g., side nearest the outermost surface 112) of the polymer layer containing the sp² carbon-containing material 110, in some embodiments the sp² carbon-containing material 116 may additionally or alternatively be disposed on the innermost side of the polymer layer having the sp² carbon-containing material 110. In some embodiments, the sp² carbon-containing material 116 may be uniformly or non-uniformly distributed throughout the polymer resin of the polymer layer having the sp² carbon-containing material 110.

In examples where the sp² carbon-containing material is attached to the plurality of fibers (e.g., glass fiber fabric), the resin applied thereto may delaminate from the plurality of fibers under high temperatures. In such examples, the difference in heat release values between the resin and the sp² carbon-containing material disposed on the plurality of fibers (e.g., the delayed peak heat release) may cause delamination of the cured resin from the plurality of fibers and the sp² carbon-containing material. Such delamination may be desirable as it would allow extinguishment of burning resins.

While described in some examples as being used in thermoset polymer layers, the sp² carbon-containing material disclosed herein may be utilized in any resin which burns, such as thermoplastics, silicone, or any other resin. The sp² carbon-containing material delays heat release in said resins thereby reducing at least the peak heat release values associated therewith. In some examples, the sp² carbon-containing materials disclosed herein may be present in a non-thermoset resin layer, such as a thermoplastic layer. In such examples, any of the polymer layers disclosed herein may be substituted for a thermoplastic layer or other resin layer containing any of the sp² carbon-containing materials disclosed herein, in any of the amounts disclosed herein. For example, the polymer layer having the sp² carbon-containing material 110 may be omitted and a thermoplastic layer having the sp² carbon-containing material may be utilized instead. In such examples, a PEI thermoplastic resin may be utilized with the fiber sheet and the sp² carbon-containing material. In some examples (not shown), a thermoplastic layer may be disposed on, below, or between any of the layers in the composite sandwich 100.

While examples of a composite sandwich structure with any three polymer layers—at least one of which includes sp² carbon-containing material—and a single core are described above as exemplars with respect to FIGS. 1 and 2, further examples of composite sandwich structures with sp² carbon-containing materials may be used.

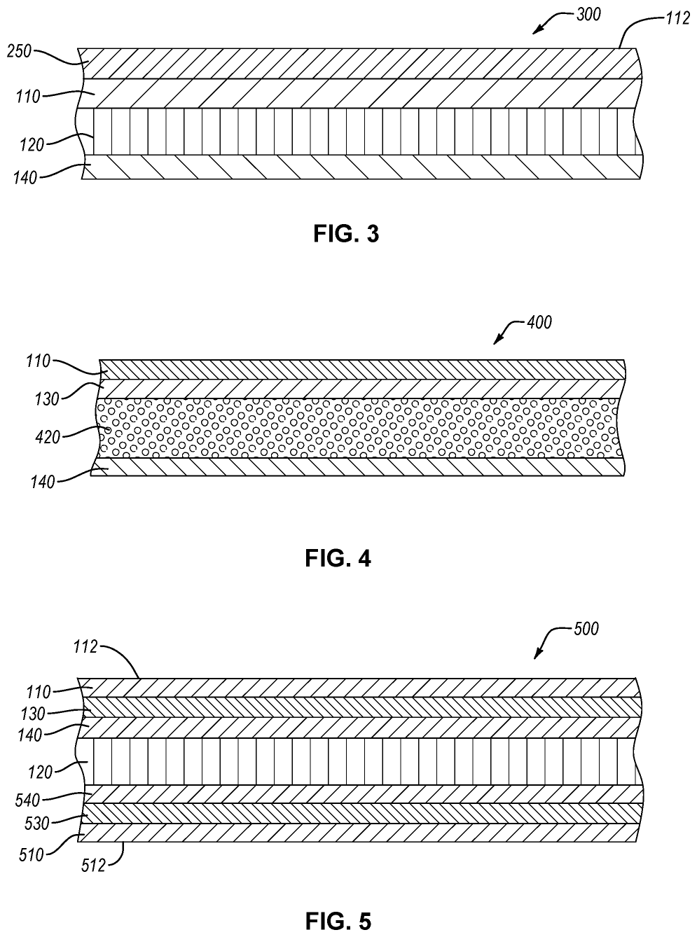

FIG. 3 is a cross-sectional view of a composite sandwich 300, according to an embodiment. The composite sandwich 300 includes a thermoplastic layer 250, the at least one polymer layer having the sp² carbon-containing material 110, the core 120, and the at least one additional polymer layer 140. The thermoplastic layer 250 may be disposed on the polymer layer having the sp² carbon-containing material 110. The polymer layer having the sp² carbon-containing material 110 may be disposed on the core 120. The core 120 may be disposed on the additional polymer layer 140.

The thermoplastic layer 250 may include a plurality of fibers disposed in a thermoplastic (polymer) resin, such as any of the plurality of fibers disclosed herein. The thermoplastic layer 250 may include a high temperature thermoplastic resin such as PEI, PEEK, PTFE, PFA, FEP, PET/PBT, aramid, other high temperature thermoplastics, or derivatives of any of the foregoing that have a melting point above 200° C. The thermoplastic layer 250 may be similar to the polymer layer having the sp² carbon-containing material 110 in one or more aspect such as dimension(s), types of fibers, etc. The thermoplastic layer 250 may be the outermost layer in the composite sandwich 300 and form the outermost surface 112 thereof. In such examples, the composite sandwich 300 may not include paint. The thermoplastic layer 250 may include a colorant therein, such as a pigment. The thermoplastic layer 250 may be bonded directly to the polymer layer having the sp² carbon-containing material 110.

In some examples, the thermoplastic layer 250 may include sp² carbon-containing material therein, such as in any of the amounts, types, or distributions disclosed herein for the polymer layer having the sp² carbon-containing material 110. In such examples, the polymer layer having the sp² carbon-containing material 110 may be omitted or may not include sp² carbon-containing material therein.

In some examples, the thermoplastic layer 250 may include a plurality of glass, carbon, thermoplastic, thermoset, or other fibers (e.g., quartz), the polymer layer having the sp² carbon-containing material 110 may include a plurality of glass, carbon, thermoplastic, or thermoset fibers, and the additional polymer layer 140 may include a plurality of carbon fibers. In such examples, the thermoplastic layer 250 may include a plurality of glass fibers, the polymer layer having the sp² carbon-containing material 110 may include a plurality of glass fibers, and the additional polymer layer 140 may include a plurality of carbon fibers. The polymer resin in any of the additional thermoset layers 130 or 140 may be any of the polymer resins disclosed herein, independent from the other layers in the composite sandwich 300. For example, the additional layer 130 may include a thermoset resin and the additional layer 140 may include a thermoplastic resin.

The high-temperature thermoplastic polymer in the thermoplastic layer 250 in combination with polymer layer having the sp² carbon-containing material 110 may serve to further lower the heat release of the composite sandwich 300 (e.g., composite laminate) compared to a composite laminate that does not utilize the thermoplastic layer 250.

In some examples, the sp² carbon-containing material may be disposed on or proximate to the core of the composite sandwich. FIG. 4 is a cross-sectional view of a composite sandwich 400, according to an embodiment. The composite sandwich 400 includes foam core 420, the at least one polymer layer having the sp² carbon-containing material 110, and the at least one additional polymer layers 130 and 140. The at least one polymer layer having the sp² carbon-containing material 110 may be disposed on the additional polymer layer 130. The additional polymer layer 130 may be disposed on the foam core 420. The foam core 420 may be disposed on the additional polymer layer 140. The at least one polymer layer having the sp² carbon-containing material 110, the additional polymer layers 130, the foam core 420, and the additional polymer resin 140 may be directly bonded to each adjacent layer in the composite sandwich 400.

The foam core 420 may be similar or identical to the core 120 in one or more aspects, such as material composition, structure, dimension(s), or the like. The foam core 420 may include a closed or open-cell foam, such as any of the foams disclosed herein. For example, the foam core 420 may include any of the polymer materials for forming a core disclosed herein such as one or more of a polycarbonate, polyethylene, polypropylene, PPS, PEEK, PEI, foamed aluminum, or a PMI-based foam.

The polymer resin in one or more of polymer layer having the sp² carbon-containing material 110 or the additional polymer layers 130 or 140 may be similar or identical to any of the polymer resins disclosed herein, independent of the core material or polymer resin in any of the adjacent layers. For example, the polymer resin in the additional thermoset layer 130 may include a thermoset or thermoplastic resin and the polymer resin in the additional polymer layer 140 may include the other of the thermoset or thermoplastic resin. in such examples, the polymer resin in the polymer layer having the sp² carbon-containing material 110 may include a thermoset resin, a thermoplastic resin, or a combination thereof. In some examples, the polymer resin which bonds the foam core 420 to one or more of the additional polymer layer 130 or 140 may include sp² carbon-containing material. For example, the polymer resin in the additional polymer layer 130 may include sp² carbon-containing material therein. In such examples, the peak heat release of the composite sandwich 400 may be delayed compared to a composite sandwich that does not have sp² carbon-containing material in the polymer resin of the additional polymer layers 130 or 140 due to the reduced heat release provided by the sp² carbon-containing material delaying burning of the foam core 420.

In some examples, a composite sandwich structure may provide the high release values disclosed herein from both major surfaces of the composite sandwich. FIG. 5 is a cross-sectional view of a composite sandwich 500, according to an embodiment. The composite sandwich 500 includes the polymer layer having the sp² carbon-containing material 110, the additional polymer layer 130, the additional polymer layer 140, the core 120, additional polymer layer 540, additional polymer layer 530, and additional polymer layer having the sp² carbon-containing material 510.

The polymer layer having the sp² carbon-containing material 110 may be disposed on the additional polymer layer 130. The additional polymer layer 130 may be disposed on the additional polymer layer 140. The additional polymer layer 140 may be disposed on the core 120. The core 120 may be disposed on the additional polymer layer 540. The additional polymer layer 540 may be disposed on the additional polymer layer 530. The additional polymer layer 540 may be disposed on the additional polymer layer having the sp² carbon-containing material 510. Any of the depicted layers of the composite sandwich 500 may be directly bonded to adjacent layers in the composite sandwich 500.

The additional polymer layers 530 and 540 may be similar to or identical to the additional polymer layers 130 and 140 in one or more aspects. For example, the additional polymer layer 530 may include a plurality of glass fibers disposed in an epoxy-polyurethane polymer resin. The additional polymer layer 540 may include a plurality of carbon fibers disposed in an epoxy-polyurethane polymer resin.

The additional polymer layer having the sp² carbon-containing material 510 may be similar or identical to the polymer layer having the sp² carbon-containing material 110 in one or more aspects. For example, the additional polymer layer having the sp² carbon-containing material 510 may include a plurality of glass fibers, sp² carbon-containing material, and an epoxy-polyurethane resin. The additional polymer layer having the sp² carbon-containing material 510 may be located on an outermost surface 512 of the composite sandwich 510, such as the surface substantially opposite the outermost surface 112. By virtue of the polymer layers having the sp² carbon-containing material 110 and 510 on each of the outermost surfaces 112 and 512, the heat release value of the composite sandwich is reduced on both sides of the composite sandwich 500 compared to composite sandwiches without the sp² carbon-containing material near the outermost surfaces. Such examples may be particularly useful where both sides of the composite sandwich may be exposed to heat sources or face people.

In some examples, one or more of the additional polymer layers 130, 140, 530, or 540 may be omitted from the composite sandwich 500. For example, in some embodiments, the additional polymer layer 540 may be omitted and only a single carbon fiber-containing layer may be included in the composite sandwich 500, such as additional polymer layer 140.

Any of layers in the composite sandwiches 100, 300, 400, or 500 may be omitted therefrom or may be used in combination with any of the other composite sandwiches 100, 300, 400, or 500.

The combination of a (first) polymer layer having the sp² carbon-containing material disposed on an additional (second) polymer layer may be used as an outer surface of a laminate composite structure. For example, the combination of a polymer layer having the sp² carbon-containing material disposed on a second polymer layer may be used as an outer surface of a seatback, dashboard, luggage, storage bin, luggage bin, bulkhead, molding, trim, arms, or other portions of vehicles, aircraft, rail, boats, etc. In such examples, the polymer layer having the sp² carbon-containing material may provide a selected heat release to the component. In some embodiments, an outer layer of paint or vinyl sticker can be applied to an outer surface of the polymer layer having the sp² carbon-containing material in addition or as an alternative to pigment in the polymer layer having the sp² carbon-containing material. Additionally, by including the additional polymer layer(s), the combination may provide a greater structural rigidity and strength than a single polymer layer having the sp² carbon-containing material. For example, another additional (third) polymer layer may be used to sandwich the core material between the additional polymer layers (e.g., second and third polymer layers) to provide a selected amount of rigidity and strength to the composite laminate structure. Moreover, by including sp² carbon-containing material in the polymer layer(s), heat release properties of the polymer layer having the sp² carbon-containing material are improved over similarly formulated and dimensioned polymer layers formed without the sp² carbon-containing material.

A layer having polymer resin (e.g., thermoset resin, thermoplastic resin, silicon resin, etc.) and sp² carbon-containing material may be used to form a monolithic component or structure, such as any of the components disclosed herein (e.g., automotive, marine, aircraft, rail, etc.). In an example, a polymer resin having sp² carbon-containing material therein may be used to form a component from a single monolithic layer of the resin. Such components would have a decreased heat release relative to components formed from similar resins or components (e.g., fiber sheets) without the sp² carbon-containing material therein. Such components would also exhibit an increase in strength, such as tensile strength, over components formed from similar resin without the sp² carbon-containing material therein. In some examples, the monolithic layer of polymer resin having sp² carbon-containing material may include a plurality of fibers therein. In some examples, the monolithic layer of resin having sp² carbon-containing material may not have any reinforcement fibers therein. The monolithic components may be molded to form a specific shape as disclosed herein with respect to composite laminates.

In some examples, monolithic components can be formed using RTM. In some examples, monolithic components can be formed from a pre-preg of a plurality of fibers containing the polymer resin and sp² carbon-containing material.

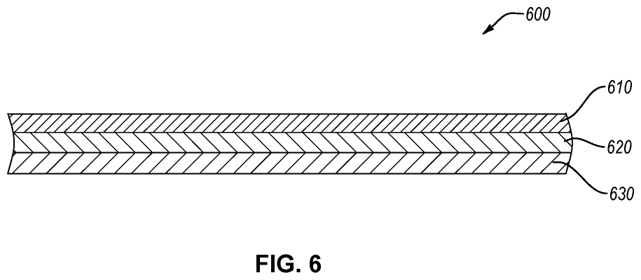

While the sp² carbon-containing material layer(s) herein are disclosed as being used in composite sandwiches (e.g., laminates), components having the sp² carbon-containing material can also be used to form monolithic components. FIG. 6 is a cross-sectional view of a monolithic composite 600, according to an embodiment. The monolithic composite 600 may be a multilayer monolithic composite as shown or a single layer monolithic composite. The monolithic composite 600 may include one or more layers having a plurality of fibers disposed in a polymer resin. For example, the monolithic composite 600 includes the first layer 610, the second layer 620, and the third layer 630. In some examples, monolithic composites may include more or fewer layers than those depicted in FIG. 6.

One or more of the first layer 610, the second layer 620, or the third layer 630 may include the sp² carbon-containing material therein, such as in a resin or on a plurality of fibers therein. For example, one or more of the first layer 610, the second layer 620, or the third layer 630 may be similar or identical to the polymer layer having the sp² carbon-containing material 110 in one or more aspects. For example, the first layer 610 may include a first plurality of fibers, a polymer (e.g., thermoset and/or thermoplastic) resin, and sp² carbon-containing material therein such as disposed in the resin or attached to the first plurality of fibers. The second layer 620 may include a polymer (e.g., thermoset and/or thermoplastic) resin disposed on a second plurality of fibers. The third layer 630 may include a polymer (e.g., thermoset and/or thermoplastic) resin disposed on a third plurality of fibers. In some examples, one or more of the second layer 620 or the third layer 630 may alternatively or additionally (relative to the first layer 610) include sp² carbon-containing material therein. The sp² carbon-containing material in any of the first layer 610, the second layer 620, or the third layer 630 may be similar or identical to any of the sp² carbon-containing materials disclosed herein.

In some examples, the polymer resins in the first layer 610, the second layer 620, and the third layer 630 may be identical to each other in one or more of material composition, amount per layer, the like. In some examples, the polymer resin in the first layer 610, the second layer 620, or the third layer 630 may be similar or identical to any of the polymer resins disclosed herein in one or more aspects. For example, the polymer resin in an individual layer may include a thermoset resin, a thermoplastic resin, or a combination thereof. The pluralities of fibers in the first layer 610, the second layer 620, and the third layer 630 may be similar or identical to any of the pluralities of fibers disclosed herein. In some examples, the pluralities of fibers in the first layer 610, the second layer 620, and the third layer 630 may be identical to each other in one or more of material composition, area density (gsm), or type (e.g., NCF, woven, randomly oriented, biaxial, multi-ply, etc.).

In some examples, the first layer 610 may include a polymer resin disposed on a plurality of glass fibers, the second layer 620 may include a polymer resin disposed on a second plurality of glass fibers, and the third layer 630 may include a polymer resin disposed on a third plurality of glass fibers. In such examples, the first layer 610 may be similar or identical to the polymer layer having sp² carbon-containing material therein 110, the second layer 620 may be similar or identical to the additional polymer layer 130, and the third layer 630 may be similar or identical to the additional polymer layer 140. For example, the first layer 610 may include a polymer resin disposed on a plurality of glass fibers, the second layer 620 may include a polymer resin disposed on a second plurality of glass fibers, and the third layer 630 may include a polymer resin disposed on a third plurality of glass fibers. In some examples, one or more of the second layer 620 or the third layer 630 may be omitted.

In some examples, the first layer 610 may include a polymer resin disposed on a plurality of carbon, the second layer 620 may include a polymer resin disposed on a second plurality of carbon fibers, and the third layer 630 may include a polymer resin disposed on a third plurality of carbon fibers. In such examples, the polymer resin may be a thermoset resin, a thermoplastic resin, or a blend thereof. By disposing the sp² carbon-containing material in the first layer 610, the underlying second layer 620 and third layer 630 may be “shielded” from heat by the sp² carbon-containing material which absorbs heat and delays the heat release as disclosed herein.

The composite sandwich structures or monolithic composites disclosed herein may be disposed in or used to form parts. Examples of such composite sandwich or monolithic components may include panels (e.g., vehicle body panels such as car hoods, vehicle interior panels such as interior bulkheads, dashboards, moldings, electrical panels, etc.), seat components, tables, trays, storage bins (e.g., overhead storage) or other storage container panels, or any other components disclosed herein.

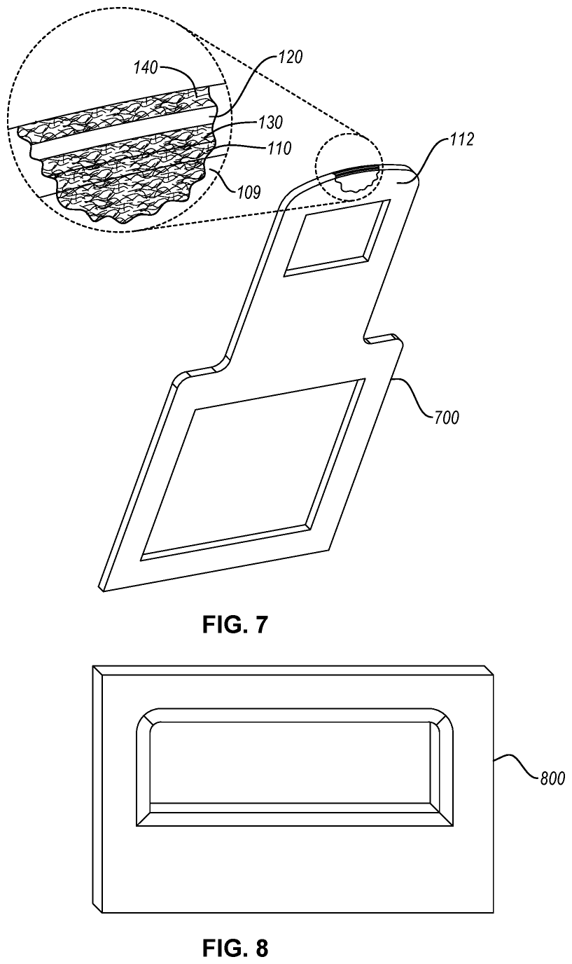

FIG. 7 is an isometric view of a seatback 700, according to an embodiment. The seatback 700 may be formed from a composite sandwich or monolithic composite. As shown, the layers of the composite in the seatback 700 may include the coating or layer of paint 109, the polymer layer having the sp² carbon-containing material 110, the additional polymer layers 130 and 140, and the core 120. The seatback 700 may be configured such that the polymer layer having the sp² carbon-containing material 110 of the composite sandwich may face outward. Likewise layers of the composite sandwich may be configured as the composite sandwich 100 with the polymer layer having the sp² carbon-containing material 110 followed by the additional polymer layer 130, the core 120, and the additional polymer layer 140. The additional polymer layer 140 may face inwardly (e.g., away from the outermost surface 112). In some embodiments (not shown), the layers of the composite in the seatback 700 may be a monolithic composite laminate. Such configuration may provide a seatback 700 with a relatively low heat release on the surface of the seatback that face a person sitting behind the seat on which the seatback is located, while still providing relatively high strength and light weight for the seatback 700.

FIG. 8 is a front view of a panel 800, according to an embodiment. The panel 800 may be formed from any of the composite sandwiches or monolithic composites disclosed herein. The panel 800 may be configured as an interior panel of a train car (e.g., subway or light rail car). The panel 800 may have molding for additional components to fit therein, such as a window.

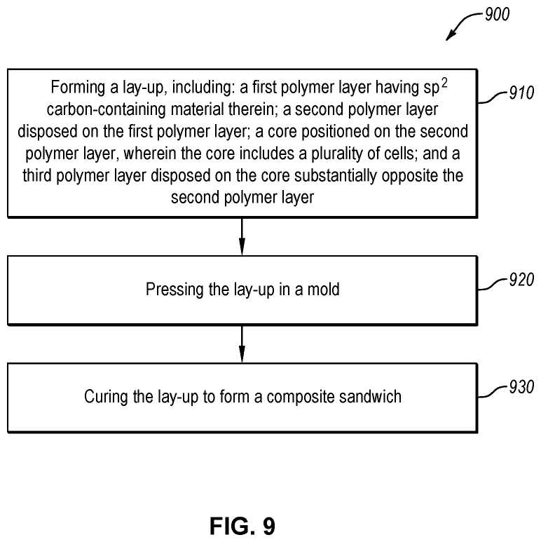

FIG. 9 is a flow chart of a method 900 of making a composite sandwich structure according to an embodiment. The method includes an act 910 of forming a lay-up, including a first polymer layer having sp² carbon-containing material therein, a second polymer layer disposed on the first polymer layer, a core positioned on the second polymer layer, wherein the core includes a plurality of cells, and a third polymer layer disposed on the core substantially opposite the second polymer layer; an act 920 of pressing the lay-up in a mold; and an act 930 of curing the lay-up to form a composite sandwich. In some examples, the acts 910-930 may be performed in different order than presented or one or more acts may be omitted. In some examples, additional acts may be included in the method 900. For example, embodiments of method 900 also can include an act of painting or coating an outermost surface of the first polymer layer distal to the second polymer layer with at least one of paint or a vinyl adhesive sticker.

The act 910 of forming a lay-up may include providing each of the components of the lay-up separately or as separate layers of the composite sandwich structure. The lay-up may be an as yet uncured set of layers (e.g., stack) of a structural component to be formed. The lay-up may include any combination of any of the layers disclosed herein, such as at least one polymer layer having the sp² carbon-containing material, at least one additional polymer layer, at least one core positioned, and optionally, one or more additional layers (e.g., metal layer(s), such as aluminum). In some examples, forming a lay-up may include providing one or more of at least one polymer (e.g., epoxy-polyurethane thermoset) layer having the sp² carbon-containing material, at least one additional polymer (e.g., epoxy-polyurethane thermoset) layer, or a core. For example, forming the lay-up may include positioning any of the polymer layer having the sp² carbon-containing material disclosed herein into a mold. The mold may be sized and shaped to provide a selected form of a part (e.g., seatback, armrest, overhead bin, etc.). The mold may have two or more mold portions disposed on a press, wherein each of the mold portions are positioned on press heads to be pressed together to compress any material(s) therebetween. Forming the lay-up may include positioning any of the additional polymer layers disclosed herein into the mold, such as on the polymer layer having the sp² carbon-containing material. Forming the lay-up may include positioning any of the cores disclosed herein into the mold, such as on the additional polymer layer. For example, the core may be disposed on the additional (second) polymer layer, or vice versa, where the open ends of the plurality of cells of the core are interfaced by the second polymer layer. Forming the lay-up may include positioning an additional (third) polymer layer into the mold, such as on the opposite the side of the core from the second polymer layer. For example, the third polymer layer may be positioned on the core where the second set of open ends of the plurality of cells of the core are interfaced by the third polymer layer. In some examples, the core may not extend along the entire lateral dimension(s) of the polymer layer(s) and/or polymer layer(s) having the sp² carbon-containing material.

In some examples, other lay-up configurations may be provided and positioned in the mold. For example, more or fewer components may be utilized in the lay-up than those described in the example above. In some examples, the lay-up may contain only a polymer layer having the sp² carbon-containing material disposed on an additional polymer layer, or only a polymer layer having the sp² carbon-containing material, an additional polymer layer, and a core. In some examples, the locations of the layers of the lay-up may differ from the examples provided above.

In some examples, forming the lay-up may include mixing the sp² carbon-containing material with polymer resin to form a polymer resin mixture having a selected distribution of sp² carbon-containing material therein (e.g., a substantially uniform distribution). The polymer resin mixture may be applied to the plurality of fibers. In embodiments, a mixture of polymer resin and sp² carbon-containing material may be formed before addition of the mixture of polymer resin and sp² carbon-containing material (e.g., graphene) to a fiber layer. The sp² carbon-containing material may be mixed with the resin until a substantially uniform distribution of sp² carbon-containing material is present throughout the volume of resin. It is noted that sp² carbon-containing materials such as graphene are particularly difficult to evenly distribute in polymer resin, therefore special equipment may be required to achieve a substantially homogenous (e.g., uniform) distribution of graphene particles (e.g., graphene sheets, carbon nanotubes, etc.) in the polymer resin. For example, a high-shear mixer or ultrasonic agitator may be used to mix polymer resin and sp² carbon-containing material in the amounts disclosed herein. The sp² carbon-containing material may be incrementally added to the resin while the high-shear mixer is agitating the mixture. Alternatively, sp² carbon-containing material and resin may be added in whole to the high-shear mixer before mixing. The high-shear mixer may be pulsed to provide short bursts (e.g., less than 10 seconds, less than 5 seconds, less than 3 seconds, or less than 2 seconds) of mixing agitation to prevent sp² carbon-containing material particles from ejecting into the air as the sp² carbon-containing material is incorporated into the resin. The sp² carbon-containing material may be added as single wall graphene tubes, multi-wall graphene tubes, graphene powder, graphene sheets, graphene flakes, graphene spirals, patterned graphene, folded graphene, any of the sp² carbon-containing materials disclosed herein, or combinations of the any of the foregoing. The sp² carbon-containing material content of a selected layer may be any of the contents disclosed herein, such as less than 10 wt % or less than 4 wt % of the first polymer layer.

Forming a lay-up may include providing a plurality of fibers (e.g., any of the pluralities of fibers disclosed herein) and then adding the polymer resin containing sp² carbon-containing material to the plurality of fibers (e.g., fiber sheet). For example, a glass fabric sheet may be provided and a polymer resin containing sp² carbon-containing material may be applied onto the glass fabric sheet. Additionally or alternatively, carbon fiber fabrics or even high melting temperature (e.g., Tg is at least about 200° C.) thermoplastic fiber fabrics may be used with the polymer layer having sp² carbon-containing material or additional polymer layer(s). Upon pressing, the polymer resin or mixture of resin and sp² carbon-containing material may infiltrate into the glass fabric and harden upon curing to form a cured polymer layer having sp² carbon-containing material therein. The polymer resin or mixture of polymer resin and sp² carbon-containing material may be applied in liquid, semi-solid, or solid form.

Forming the lay-up may include applying a polymer resin onto the plurality of fibers of a selected layer such as to at least partially impregnate the fiber fabric with the mixture of polymer resin, and the sp² carbon-containing material when present in the resin. When the sp² carbon-containing material is affixed to the plurality of fibers, the polymer resin may be applied thereto, may at least partially cover the sp² carbon-containing material and impregnate the plurality of fibers. The sp² carbon-containing material may be retained on the plurality of fibers via the polymer resin. In some examples, the polymer resin or mixture of polymer resin and sp² carbon-containing material may be heated to a suitable viscosity for spraying and may be sprayed onto a fiber fabric (e.g., plurality of fibers). For example, forming the polymer layer containing the sp² carbon-containing material may include applying a mixture of polymer resin and sp² carbon-containing material onto a fiber fabric (e.g., layer 110) such as to at least partially impregnate the fiber fabric with the mixture of polymer resin and sp² carbon-containing material. In some examples, forming the lay-up may include applying a polymer resin with or without sp² carbon-containing material therein onto a fiber fabric and an additional fiber fabric (e.g., layers 130 and 140) such as to at least partially impregnate the first and second fiber fabrics with the polymer resin, such as an epoxy-polyurethane resin. In some examples, forming the lay-up may include applying the polymer resin mixture having the sp² carbon-containing material therein to a plurality of fibers to form a layer having a selected distribution of sp² carbon-containing material therein, such as a higher concentration of sp² carbon-containing material on an outer facing surface of the plurality of fibers than on an inner facing surface thereof. In some examples, spraying the polymer resin or the mixture of the polymer resin and sp² carbon-containing material may be carried out at a pressure of less than about 90 psi onto the fiber fabric. In some examples, the polymer resin or the mixture of polymer resin and sp² carbon-containing material be manually spread onto the fiber fabric, such as by a spatula or the like. In some examples, the plurality of fibers may be provided as a pre-preg material, that is, a plurality of fibers containing at least some of the polymer resin or the mixture of polymer resin and sp² carbon-containing material, depending on the layer. In such examples, the pre-preg may include a larger amount of polymer resin on one surface or side thereof. For example, an outermost layer may have a larger amount of polymer resin (e.g., thermoplastic) thereon to provide a selected surface finish. Such polymer resin may be provided in powder form.

The polymer resin and sp² carbon-containing material combination may be applied to and/or embedded in the plurality of fibers by one or more of spraying, manually spreading (e.g., by trowel, roller, brush, or spatula), or otherwise coating. For example, a fiber layer having any of the densities (in g/m² (“gsm”)) disclosed herein can be coated by a predetermined mass of resin per square meter of fiber, such as at least 1 gram of resin per square meter of fiber, at least 10 grams of resin per square meter of fiber, at least 20 grams of resin per square meter of fiber, at least 30 grams of resin per square meter of fiber, at least 40 grams of resin per square meter of fiber, at least 50 grams of resin per square meter of fiber, at least 60 grams of resin per square meter of fiber, at least 70 grams of resin per square meter of fiber, at least 80 grams of resin per square meter of fiber, at least 90 grams of resin per square meter of fiber, at least 100 grams of resin per square meter of fiber, at least 150 grams of resin per square meter of fiber, at least 200 grams of resin per square meter of fiber, 1 to 200 grams of resin per square meter of fiber, 10 to 150 grams of resin per square meter of fiber, 20 to 100 grams of resin per square meter of fiber, 30 to 80 grams of resin per square meter of fiber, 35 to 70 grams of resin per square meter of fiber, 40 to 60 grams of resin per square meter of fiber, 45 to 55 grams of resin per square meter of fiber, 47 to 52 grams of resin per square meter of fiber, 48 to 50 grams of resin per square meter of fiber, about 48 grams of resin per square meter of fiber, less than 200 grams of resin per square meter of fiber, less than 150 grams of resin per square meter of fiber, less than 100 grams of resin per square meter of fiber, less than 90 grams of resin per square meter of fiber, less than 80 grams of resin per square meter of fiber, less than 70 grams of resin per square meter of fiber, less than 60 grams of resin per square meter of fiber, less than 50 grams of resin per square meter of fiber, less than 40 grams of resin per square meter of fiber, less than 30 grams of resin per square meter of fiber, less than 20 grams of resin per square meter of fiber, or less than 10 grams of resin per square meter of fiber. In some examples, the distribution of resin in a layer may not be uniform. For example, one side or surface of the plurality of fibers (e.g., fiber sheet) in a selected layer may have a larger or lesser amount of resin thereon than the opposite side.

Forming the lay-up may include affixing the affixing the sp² carbon-containing material on a plurality of fibers of the one or more polymer layers, such as the first polymer layer. In some examples, affixing the sp² carbon-containing material on the plurality of fibers may include adhering the sp² carbon-containing material on a plurality of fibers with an adhesive, such as a polymer adhesive. In some examples, affixing the sp² carbon-containing material on the plurality of fibers may include growing the sp² carbon-containing material on the plurality of fibers, such via chemical vapor deposition as disclosed herein (e.g., using seed material). For example, graphene flakes may be produced by depositing cobalt or another seed material on the plurality of fibers in a selected distribution (e.g., selected side, density, and/or pattern) and exposing the seed material to acetylene under selected conditions to build the carbon structure of the sp² carbon-containing material. Other chemical vapor deposition, graphene production, or carbon nanotube production techniques may be used to grow the sp² carbon-containing material on the plurality of fibers. For example, affixing the sp² carbon-containing material on a plurality of fibers of the first polymer layer may include growing the sp² carbon-containing material on a first side of a fiber fabric via chemical vapor deposition.

In some examples, the forming the lay-up may include affixing the sp² carbon-containing material on a plurality of fibers of the first polymer layer and orienting the sp² carbon-containing material (e.g., graphene flakes) in a direction parallel to a major axis of first polymer layer or composite sandwich as disclosed herein, such as in a parallel planar configuration. For example, a magnetic field may be used to manipulate the orientation of the cobalt seed material after growing graphene thereon. Accordingly, the graphene on the seed material may be likewise manipulated by the magnetic field. In some examples, the plane or major axis of the sp² carbon-containing material in a selected layer may be oriented parallel, perpendicular, obliquely, or randomly to the major axis of the polymer layer, fiber sheet therein, or composite sandwich to selectively tune the heat release properties of the composite sandwich. In some examples, the sp² carbon-containing material may be grown in the selected orientation. For example, the seed material may be selectively positioned on the carbon fibers and the sp² carbon-containing material may be grown in the selected orientation by selectively controlling the CVD conditions.

Forming the lay-up may include providing a pre-molded polymer layer having sp² carbon-containing material therein. For example, a plurality of fibers bearing the mixture of polymer resin and sp² carbon-containing material thereon and/or therein may be pressed in the mold, heated to a curing temperature, and cooled to form a pre-molded polymer layer having sp² carbon-containing material therein. Spraying the mixture of polymer resin and sp² carbon-containing material on a fabric layer and then molding the layer allows the sp² carbon-containing material to be distributed on or throughout the polymer layer having sp² carbon-containing material in selected amounts, and remain in places distributed on or throughout the polymer layer having sp² carbon-containing material after molding. For example, the polymer resin (e.g., mixture of polymer resin and sp² carbon-containing material) may be applied to only one surface of the plurality of fibers (e.g., fiber fabric) in the polymer layer having the sp² carbon-containing material or may be applied in a greater amount on one side of the plurality of fibers than the other. The remaining layers of the lay-up may be positioned in/on the pre-molded polymer layer having sp² carbon-containing material to provide at least a rough contour of the finished (e.g., molded) part. Accordingly, upon pressing the pre-molded polymer layer and the remaining materials in the lay-up may be more readily pressed into the corners of the mold to give the full final form of the part defined by the mold.

Pre-molding the polymer layer(s) is particularly effective with glass fibers or carbon fibers, as glass fibers and carbon fibers do not deform or stretch very much, if at all, compared to thermoplastic polymer fibers. Accordingly, by pre-molding the one or more of polymer layer(s) and placing the remaining components of the lay-up on the pre-molded polymer layer(s), the polymer layer(s) containing glass fibers can be molded to at least near the final shape of the mold and the remaining components can be manipulated into the pre-molded portions of the polymer layer to more readily provide the final shape of the molded part. This reduces incomplete molding, particularly in the polymer layer(s), such as lack of complete definition in corners of the molded part. Forming the lay-up may include abrading the pre-molded polymer layer(s) on a surface that is intended to be bound to the additional polymer layer or polymer layer having sp² carbon-containing material, such as with a scouring pad, steel wool, a file, or any other tool suitable for abrading a surface.

Forming the lay-up may include applying a polymer resin having no sp² carbon-containing material therein onto a plurality of fibers to at least partially impregnate the fiber fabric with the polymer resin to form an additional polymer layer, such as any of the additional polymer layers disclosed herein. Forming the lay-up may include applying a thermoplastic (e.g., PEI) resin having no sp² carbon-containing material therein onto a plurality of fibers to at least partially impregnate the fiber fabric with the thermoplastic resin to form the thermoplastic layer, such as any of the additional thermoplastic layers disclosed herein. In some examples, the thermoplastic layer may not include the plurality of fibers therein.

In some examples, the first polymer layer may include a plurality of glass fibers, the second polymer layer may include a plurality of glass fibers or a plurality of carbon fibers, and the third polymer layer may include a plurality of glass fibers or a plurality of carbon fibers. In some examples, the first polymer may include a first plurality of glass fibers having a density of 80 grams per square meter (“gsm”) and the sp² carbon-containing material, the second polymer layer may include a second plurality of glass fibers having a density of 220 gsm, the third polymer layer may include plurality of carbon fibers having a density of 300 gsm, and forming a lay-up includes applying an polymer (e.g., epoxy-polyurethane) resin to one or more of the first plurality of glass fibers, the second plurality of glass fibers, or the plurality of carbon fibers.

The core of the lay-up may include any of the cores disclosed herein such as a plurality of parallel tubes, a honeycomb core, a foam core, or the like. The core may have any of the material compositions or thicknesses disclosed herein. In some examples, forming a lay-up may include disposing a high-temperature thermoplastic layer on the first polymer layer, such as any of the high-temperature thermoplastics disclosed herein, such as a polyetherimide resin.

The act 920 of pressing the lay-up in a mold may include closing the mold and further include applying an external pressure to the mold, such as to compress one or more components (e.g., layers) therein. Method 900 may also optionally include vacuuming the cavity of the mold. For example, it may be desired to vacuum the mold to remove the trapped air in the plurality of fibers and/or resins of various layers when the composite sandwich structure is formed.

Pressing the mold may include applying pressure to at least partially close the mold to form a composite sandwich structure (e.g., a composite laminate) having the shape of the mold and/or at least partially collapse the core. The pressure applied on the lay-up may be sufficient to at least partially collapse the core and/or to at least partially force air out of the plurality of fibers in one or more of the polymer layer(s) having sp² carbon-containing material or the additional polymer layer(s). Suitable techniques for compressing composite laminate structures in molds are disclosed in International Patent Application No. PCT/US15/34070, filed on 3 Jun. 2015; International Patent Application No. PCT/US15/34061, filed on 3 Jun. 2015; and International Patent Application No. PCT/US15/34072, filed on 3 Jun. 2015; the disclosure of each of which is incorporated herein, in its entirety, by this reference.

In embodiments, heat may be simultaneously applied to at least partially heat one or more of the polymer layer(s) having sp² carbon-containing material, the additional polymer layer(s), the core, or any materials in the lay-up while pressing the lay-up. For example, pressing the lay-up in the mold may include pressing the lay-up in a heated mold. The core may become more pliable upon application of heat during pressing, such that the core at least partially softens or melts, while compressing to increase compliance with the shape of the mold. The polyurethane in the polymer resin(s) may more readily form micro-foams upon application of heat during pressing. The mold or press may also include one or more heat elements to apply heat to the lay-up while pressing the lay-up in the mold. The polymer resin(s) may at least begin curing upon application of heat in the mold.

The act 930 of curing the lay-up to form a composite sandwich may include curing the lay-up in the mold. Curing the lay-up may include heating the polymer resin, composite laminate, or composite sandwich, in one or more of the mold, a kiln, or an oven. For example, curing the lay-up in the mold may include heating the lay-up in the mold, such as during or after pressing the lay-up. Curing the lay-up may include at least partially curing one or more of the polymer resin(s) or thermoplastic resin(s) in the lay-up. Curing the lay-up to form a composite sandwich may include curing the lay-up in the mold, such as heating the lay-up in the mold, while applying pressure to the lay-up. Curing the lay-up to form the composite sandwich includes one or more of heating the lay-up while pressing the lay-up in the mold or allowing the lay-up to cool to an ambient temperature after pressing the lay-up in the mold.

Curing the polymer resin and/or thermoplastic resin may include heating the fiber sandwich structure (or a precursor thereof such as a stack) containing the respective resin (in the mold or outside of the mold) to about 90° C. or more, such as about 110° C. or more, about 120° C. to about 200° C., about 130° C. to about 180° C., about 140° C. to about 160° C., about 120° C., about 130° C., about 140° C., or about 160° C. Depending on the composition of the resin, curing the polymer resin or the mixture of resin and sp² carbon-containing material may take place over a duration of about 40 seconds or more, such as about 40 seconds to about 1 day, about 1 minute to about 12 hours, about 90 seconds to about 8 hours, about 2 minutes to about 4 hours, about 40 seconds to about 10 minutes, about 1 minute to about 8 minutes, about 5 minutes to about 20 minutes, about 8 minutes to about 15 minutes, about 90 seconds to about 5 minutes, about 3 minutes, about 6 minutes or less, about 8 minutes or less, or about 20 minutes or less. In some examples, curing the lay-up may be carried out in the mold, such as by heating the lay-up to at least a curing temperature of the polymer(s) in the lay-up. In some examples, curing (heating) the lay-up may be partially carried out in the mold and then may be completed in a different location such as an oven or kiln. The resulting cured composite sandwich structure may have the shape defined by the mold. The shape may include any of those shapes or composite components disclosed herein, such as a vehicle body panel, a seat component, a vehicle interior panel, a storage container panel, or the like.

The method 900 may further include cooling the lay-up (e.g., now at least partially cured composite sandwich structure) after curing the lay-up. For example, the at least partially cured sandwich structure may be allowed to cool in ambient temperature, a refrigerated environment, a cooling tunnel, or by otherwise passing air over the sandwich structure.

The method 900 may include utilizing resin transfer molding or a pre-preg to form the composite laminate structure. For example, the plurality of fibers (with or without sp² carbon-containing material attached thereto) may be placed into a lay-up in a mold and resin (with or without sp² carbon-containing material therein) may be injected into the mold such that the resin impregnates the plurality of fibers in the lay-up to form a composite laminate structure. In some examples, a lay-up including a pre-preg (with or without the sp² carbon-containing material therein) may be disposed within a mold and pressed in the mold to form a part. A resin (with or without sp² carbon-containing material therein) may be applied to the pre-preg prior to compressing the lay-up in the mold.

The method 900 may include trimming flashing from the composite sandwich after curing the lay-up. The composite sandwiches formed from the method 900 may include any of the shapes disclosed herein, any of the mechanical properties disclosed herein, or any of the heat release properties disclosed herein (e.g., below 70 kW*min/m²).

Methods having acts similar or identical to any of the acts of the method 900 may be used to form other composite structures than the embodiments of the composite sandwiches disclosed in the method 900.

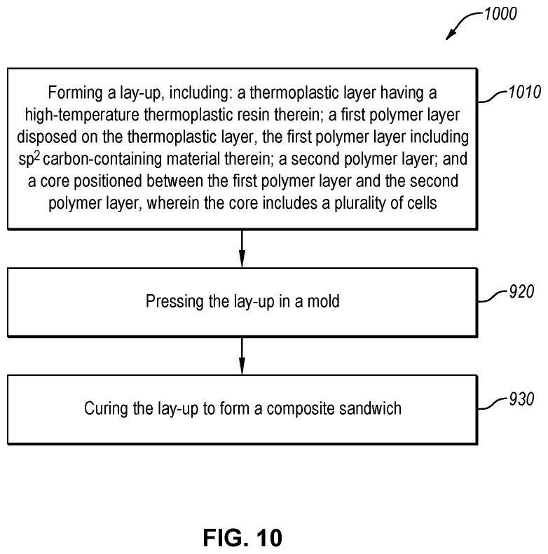

FIG. 10 is a flow chart of a method 1000 of making a composite sandwich structure according to an embodiment. The method includes an act 1010 of forming a lay-up, including a thermoplastic layer having a high-temperature thermoplastic resin therein, a first polymer layer disposed on the thermoplastic layer, the first polymer layer including sp² carbon-containing material therein, a second polymer layer, and a core positioned between the first polymer layer and the second polymer layer, wherein the core includes a plurality of cells; an act 920 of pressing the lay-up in a mold; and an act 930 of curing the lay-up to form a composite sandwich. In some examples, the acts 1010, 920, or 930 may be performed in different order than presented or one or more acts may be omitted. In some examples, additional acts may be included in the method 900. For example, embodiments of method 1000 also can include an act of painting or coating an outermost surface of the thermoplastic layer with at least one of paint or a vinyl adhesive sticker.

The act 1010 of forming a lay-up may be similar or identical to the act 910 disclosed above in one or more aspects. The act 1010 of forming a lay-up may include providing each of the components of the lay-up separately or as separate layers of the composite sandwich structure. The lay-up may be an as yet uncured set of layers (e.g., stack) of a structural component to be formed. The lay-up may include a thermoplastic layer having a high-temperature thermoplastic resin therein; a first polymer layer disposed on the thermoplastic layer, the first polymer layer including sp² carbon-containing material therein; a second polymer layer; and a core positioned between the first polymer layer and the second polymer layer, wherein the core includes a plurality of cells. The lay-up may include any combination of any of the layers disclosed herein. Forming the lay-up may include positioning any of portions of the lay-up into a mold, such as the thermoplastic layer or the (first) polymer layer having the sp² carbon-containing material. The mold may be as described above with respect to the method 1000. Forming the lay-up may include positioning any of the layers disclosed herein into the mold, such positioning the polymer (e.g., thermoset) layer having the sp² carbon-containing material on the thermoplastic layer. Forming the lay-up may include positioning any of the cores disclosed herein into the mold, such as on the polymer layer having the sp² carbon-containing material. For example, the core may be disposed on the polymer layer having the sp² carbon containing material therein, or vice versa, where the open ends of the plurality of cells of the core are interfaced by the polymer layer having the sp² carbon containing material therein. Forming the lay-up may include positioning any of the additional (second) polymer layers disclosed herein into the mold, such positioning the additional polymer (e.g., thermoset) layer on the core. In some examples, the core may not extend along the entire lateral dimension(s) of the polymer layer(s) and/or polymer layer(s) having the sp² carbon-containing material.

In some examples, other lay-up configurations may be provided and positioned in the mold. For example, more or fewer components may be utilized in the lay-up than those described in the example above. Forming the lay-up may also include positioning an additional (third) polymer layer into the mold, such as on the (first) polymer layer having the sp² carbon containing material, the additional (second) polymer layer, or the core. For example, the additional (third) polymer layer may be positioned on the core, on the opposite side of the core from the additional (second) polymer layer, where the open ends of the plurality of cells of the core are interfaced by the third polymer layer. In some examples, the locations of the layers of the lay-up may differ from the examples provided above.

In some examples, forming the lay-up may include mixing the sp² carbon-containing material with polymer resin to form a polymer resin mixture having a selected distribution of sp² carbon-containing material therein (e.g., a substantially uniform distribution). The polymer resin mixture may be applied to the plurality of fibers. In embodiments, a mixture of polymer resin and sp² carbon-containing material may be formed before addition of the mixture of polymer resin and sp² carbon-containing material to a fiber layer, as disclosed above with respect to the method 900. For example, a high-shear mixer or ultrasonic agitator may be used to mix polymer resin and sp² carbon-containing material in the amounts disclosed herein as disclosed above. The sp² carbon-containing material may be added as single wall graphene tubes, multi-wall graphene tubes, graphene powder, graphene sheets, graphene flakes, graphene spirals, patterned graphene, folded graphene, any of the sp² carbon-containing materials disclosed herein, or combinations of the any of the foregoing. The sp² carbon-containing material content of a selected layer may be any of the contents disclosed herein, such as less than 10 wt % or less than 4 wt % of the first polymer layer.

Forming a lay-up may include providing a plurality of fibers (e.g., any of the pluralities of fibers disclosed herein) and then adding the polymer resin containing sp² carbon-containing material to the plurality of fibers (e.g., fiber sheet) as disclosed herein. For example, a glass fabric sheet may be provided and a polymer resin containing sp² carbon-containing material may be applied onto the glass fabric sheet, carbon fiber fabrics, or even high melting temperature thermoplastic fiber fabrics may be used with the polymer layer having sp² carbon-containing material or additional polymer layer(s). Upon pressing, the polymer resin or mixture of resin and sp² carbon-containing material may infiltrate into the glass fabric and harden upon curing to form a cured polymer layer having sp² carbon-containing material therein. The polymer resin or mixture of polymer resin and sp² carbon-containing material may be applied in liquid, semi-solid, or solid form.

In some examples, forming the lay-up may include mixing the sp² carbon-containing material with polymer resin to form a polymer resin mixture having a selected distribution of sp² carbon-containing material therein (e.g., a substantially uniform distribution). The polymer resin mixture may be applied to the plurality of fibers.

Forming the lay-up may include applying a polymer resin onto the plurality of fibers of a selected layer such as to at least partially impregnate the fiber fabric with the mixture of polymer resin, and the sp² carbon-containing material when present in the resin. When the sp² carbon-containing material is affixed to the plurality of fibers, the polymer resin may be applied thereto, may at least partially cover the sp² carbon-containing material and impregnate the plurality of fibers. The sp² carbon-containing material may be retained on the plurality of fibers via the polymer resin, such as a thermoset resin. In some examples, the polymer resin or mixture of polymer resin and sp² carbon-containing material may be heated to a suitable viscosity for spraying and may be sprayed as disclosed herein. In some examples, forming the lay-up may include applying the polymer resin mixture having the sp² carbon-containing material therein to a plurality of fibers to form a layer having a selected distribution of sp² carbon-containing material therein, such as a higher concentration of sp² carbon-containing material on an outer facing surface of the plurality of fibers than on an inner facing surface thereof. In some examples, spraying the polymer resin or the mixture of the polymer resin and sp² carbon-containing material may be carried out at a pressure of less than about 90 psi onto the fiber fabric. In some examples, the polymer resin or the mixture of polymer resin and sp² carbon-containing material may be manually spread onto the fiber fabric, such as by a spatula or the like. The polymer resin or the mixture of polymer resin and sp² carbon-containing material may be applied to a selected layer in a selected distribution, such as a greater amount on one side of the plurality of fibers than another or evenly distributed on both sides. For example, it may be desirable to put a greater amount of thermoplastic resin on an outermost surface of an outermost layer to provide a selected surface finish to the final part. In some examples, the plurality of fibers may be provided as a pre-preg material, that is, a plurality of fibers containing at least some of the polymer resin or the mixture of polymer resin and sp² carbon-containing material, depending on the layer. In such examples, the polymer resin or mixture of polymer resin and sp² carbon-containing material may be present in a greater amount on one side of the plurality of fibers in the pre-preg than the other or may be evenly distributed.

The polymer resin and sp² carbon-containing material combination may be applied to and/or embedded in the plurality of fibers by one or more of spraying, manually spreading (e.g., by trowel, roller, brush, or spatula), or otherwise coating. For example, a fiber layer having any of the densities disclosed herein can be coated by a predetermined mass of resin per square meter of fiber, such as any of the masses of resin per square meter of fiber disclosed above (e.g., at least 1 gram of resin per square meter of fiber, 1 to 200 grams of resin per square meter of fiber, etc.).

Forming the lay-up may include affixing the sp² carbon-containing material on a plurality of fibers of the one or more polymer layers, such as the first polymer layer as disclosed herein. For example, affixing the sp² carbon-containing material on the plurality of fibers may include growing the sp² carbon-containing material on the plurality of fibers, such via chemical vapor deposition as disclosed herein (e.g., using seed material) as disclosed herein. In such examples, affixing the sp² carbon-containing material on a plurality of fibers of the first polymer layer may include growing the sp² carbon-containing material on a first side of a fiber fabric via chemical vapor deposition.

In some examples, the forming the lay-up may include affixing the sp² carbon-containing material on a plurality of fibers of the first polymer layer and orienting the sp² carbon-containing material (e.g., graphene flakes) in a direction parallel to a major axis of first polymer layer or composite sandwich as disclosed herein. For example, a magnetic field may be used to manipulate the orientation of the cobalt seed material after growing graphene thereon. Accordingly, the graphene on the seed material may be likewise manipulated by the magnetic field. In some examples, the plane or major axis of the sp² carbon-containing material in a selected layer may be oriented parallel, perpendicular, obliquely, or randomly to the major axis of the polymer layer, fiber sheet therein, or composite sandwich to selectively tune the heat release properties of the composite sandwich. In some examples, the sp² carbon-containing material may be grown in the selected orientation. For example, the seed material may be selectively positioned on the carbon fibers and the sp² carbon-containing material may be grown in the selected orientation by selectively controlling the CVD conditions.

Forming the lay-up may include providing a pre-molded polymer layer having sp² carbon-containing material therein as disclosed above. Spraying the mixture of polymer resin and sp² carbon-containing material on a fabric layer and then molding the layer allows the sp² carbon-containing material to be distributed on or throughout the polymer layer having sp² carbon-containing material, and remain in places distributed on or throughout the polymer layer having sp² carbon-containing material after molding. The remaining layers of the lay-up may be positioned in/on the pre-molded polymer layer having sp² carbon-containing material to provide at least a rough contour of the finished (e.g., molded) part. Accordingly, upon pressing the pre-molded polymer layer and the remaining materials in the lay-up may be more readily pressed into the corners of the mold to give the full final form of the part defined by the mold. Forming the lay-up may include abrading the pre-molded polymer layer(s) on a surface that is intended to be bound to the thermoplastic layer, additional polymer layer, or polymer layer having the sp² carbon-containing material, such as with a scouring pad, steel wool, a file, or any other tool suitable for abrading a surface.

In some examples, the thermoplastic layer may include a plurality of glass fibers, the (first) polymer layer having the sp² carbon-containing materials may include a plurality of glass fibers, the additional (second) polymer layer may include a plurality of glass fibers or a plurality of carbon fibers, and the optional additional (third) polymer layer may include a plurality of glass fibers or a plurality of carbon fibers. In some examples, the thermoplastic layer may include an optional plurality of glass fibers having a density of 80 or 220 gsm, the first polymer layer may include a first plurality of glass fibers having a density of 80 or 220 gsm and the sp² carbon-containing material, the second polymer layer may include a second plurality of glass fibers having a density of 220 gsm, and forming a lay-up may include applying an epoxy-polyurethane resin to one or more of the first plurality of glass fibers, the second plurality of glass fibers, or the plurality of carbon fibers.

The core of the lay-up may include any of the cores disclosed herein such as a plurality of parallel tubes, a honeycomb core, a foam core, or the like. The core may have any of the material compositions or thicknesses disclosed herein. In some examples, forming a lay-up may include disposing a third polymer layer on the first polymer layer, such as between the core and the first polymer layer.

The act 920 of pressing the lay-up in a mold may be as described above with respect to the method 900.

The act 930 of curing the lay-up to form a composite sandwich may be as described above with respect to the method 900.

The method 1000 may further include cooling the lay-up (e.g., now at least partially cured composite sandwich structure) after curing the lay-up. For example, the at least partially cured sandwich structure may be allowed to cool in ambient temperature, a refrigerated environment, a cooling tunnel, or by otherwise passing air over the sandwich structure.

The method 1000 may include utilizing resin transfer molding or a pre-preg to form the composite laminate structure. For example, the plurality of fibers (with or without sp² carbon-containing material attached thereto) may be placed into a lay-up in a mold and resin (with or without sp² carbon-containing material therein) may be injected into the mold such that the resin impregnates the plurality of fibers in the lay-up to form a composite laminate structure. In some examples, a lay-up including a pre-preg (with or without the sp² carbon-containing material therein) may be disposed within a mold and pressed in the mold to form a part. A resin (with or without sp² carbon-containing material therein) may be applied to the pre-preg prior to compressing the lay-up in the mold.

The method 1000 may include trimming flashing from the composite sandwich after curing the lay-up.

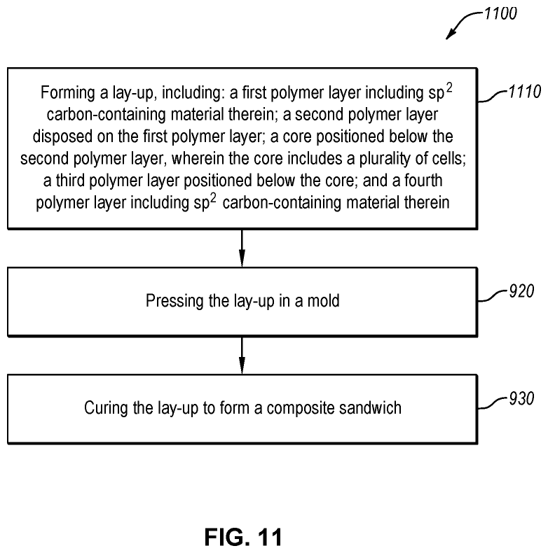

FIG. 11 is a flow chart of a method 1100 of making a composite sandwich structure according to an embodiment. The method includes an act 1110 of forming a lay-up, including a first polymer layer including sp² carbon-containing material therein, a second polymer layer disposed on the first polymer layer, a core positioned below the second polymer layer, wherein the core includes a plurality of cells a third polymer layer positioned below the core, and a fourth polymer layer including sp² carbon-containing material therein; an act 920 of pressing the lay-up in a mold; and an act 930 of curing the lay-up to form a composite sandwich. In some examples, the acts 1110, 920, or 930 may be performed in different order than presented or one or more acts may be omitted. In some examples, additional acts may be included in the method 1100. For example, embodiments of method 1100 also can include an act of painting or coating one or more outermost surfaces of the first polymer layer including sp² carbon-containing material therein or the fourth polymer layer including sp² carbon-containing material therein with at least one of paint or a vinyl adhesive sticker.

The act 1110 of forming a lay-up may be similar or identical to the acts 910 or 1010 disclosed above, in one or more aspects. The act 1110 of forming a lay-up may include providing each of the components of the lay-up separately or as separate layers of the composite sandwich structure. The lay-up may be an as yet uncured set of layers (e.g., stack) of a structural component to be formed. The lay-up may include a first polymer layer including sp² carbon-containing material therein; a second polymer layer disposed on the first polymer layer; a core positioned below the second polymer layer, wherein the core includes a plurality of cells a third polymer layer positioned below the core; and a fourth polymer layer including sp² carbon-containing material therein. Accordingly, the lay-up and resulting composite sandwich structure include outermost surfaces having sp² carbon-containing material therein. Such examples provide relatively low heat release from any surface compared composite sandwiches without sp² carbon-containing material therein. In some examples, the lay-up may include any combination of any of the layers disclosed herein.

Forming the lay-up may include positioning any portions of the lay-up into a mold, such as the (first) polymer layer having the sp² carbon-containing material, the additional (second and third) polymer layers, the core, and the (fourth) polymer layer having the sp² carbon-containing material. The mold may be as described above with respect to the method 900. Forming the lay-up may include positioning any of the layers disclosed herein into the mold, such positioning the polymer layer having the sp² carbon-containing material on the thermoplastic layer. Forming the lay-up may include positioning any of the cores disclosed herein into the mold, such as on the additional (second) polymer layer. For example, the core may be disposed on the second polymer layer, where the open ends of the plurality of cells of the core are interfaced by the second polymer layer. Forming the lay-up may include positioning any of the additional (second or third) polymer layers disclosed herein into the mold, such positioning the additional polymer layer(s) on the core. In some examples, the core may not extend along the entire lateral dimension(s) of the polymer layer(s) and/or polymer layer(s) having the sp² carbon-containing material.

In some examples, other lay-up configurations may be provided and positioned in the mold. For example, more or fewer components may be utilized in the lay-up than those described in the example above. Forming the lay-up may also include positioning an additional (third) polymer layer into the mold, such as on the core. For example, the additional (third) polymer layer may be positioned on the core, on the opposite side of the core from the additional (second) polymer layer, where the open ends of the plurality of cells of the core are interfaced by the third polymer layer. In some examples, the locations of the layers of the lay-up may differ from the examples provided above. Forming the lay-up may also include positioning a new (fourth) polymer layer sp² carbon-containing material therein onto the additional (third) polymer layer.

In some examples, forming the lay-up may include mixing the sp² carbon-containing material with polymer resin to form a polymer resin mixture having a selected distribution of sp² carbon-containing material therein (e.g., a substantially uniform distribution). The polymer resin mixture may be applied to one or more pluralities of fibers. In embodiments, a mixture of polymer resin and sp² carbon-containing material may be formed before addition of the mixture of polymer resin and sp² carbon-containing material to a fiber layer, as disclosed above with respect to the method 900. For example, a high-shear mixer or ultrasonic agitator may be used to mix polymer resin and sp² carbon-containing material in the amounts disclosed herein as disclosed above. The sp² carbon-containing material may be added as single wall graphene tubes, multi-wall graphene tubes, graphene powder, graphene sheets, graphene flakes, graphene spirals, patterned graphene, folded graphene, any of the sp² carbon-containing materials disclosed herein, or combinations of the any of the foregoing. The sp² carbon-containing material content of a selected layer may be any of the contents disclosed herein, such as less than 10 wt % or less than 4 wt % of the first polymer layer.

Forming a lay-up may include providing a plurality of fibers (e.g., any of the pluralities of fibers disclosed herein) and then adding the polymer resin containing sp² carbon-containing material to the plurality of fibers (e.g., fiber sheet) as disclosed herein to form one or more polymer layers having sp² carbon-containing material therein. For example, a glass fabric sheet may be provided and a polymer resin containing sp² carbon-containing material may be applied onto the glass fabric sheet, carbon fiber fabrics, or even high melting temperature thermoplastic fiber fabrics may be used with the polymer layer having sp² carbon-containing material or additional polymer layer(s). Upon pressing, the polymer resin or mixture of resin and sp² carbon-containing material may infiltrate into the glass fabric and harden upon curing to form a cured polymer layer having sp² carbon-containing material therein. The polymer resin or mixture of polymer resin and sp² carbon-containing material may be applied in liquid, semi-solid, or solid form.

In some examples, forming the lay-up may include mixing the sp² carbon-containing material with polymer resin to form a polymer resin mixture having a selected distribution of sp² carbon-containing material therein (e.g., a substantially uniform distribution). The polymer resin mixture may be applied to the plurality of fibers. The polymer resin in any of the a first polymer layer including sp² carbon-containing material therein, a second polymer layer, a third polymer layer, and a fourth polymer layer including sp² carbon-containing material therein, may be similar or identical to any of the polymer resins disclosed herein, such as a thermoset resin (e.g., epoxy-polyurethane resin), a thermoplastic resin (e.g., PEI resin), or thermoset-thermoplastic blend, with or without sp² carbon-containing material therein.

Forming the lay-up may include applying a polymer resin onto the plurality of fibers of a selected layer such as to at least partially impregnate the fiber fabric with the mixture of polymer resin and the sp² carbon-containing material (when present in the resin). When the sp² carbon-containing material is affixed to the plurality of fibers, the polymer resin may be applied thereto, may at least partially cover the sp² carbon-containing material and impregnate the plurality of fibers. The sp² carbon-containing material may be retained on the plurality of fibers via the polymer resin. In some examples, the polymer resin or mixture of polymer resin and sp² carbon-containing material may be heated to a suitable viscosity for spraying and may be sprayed as disclosed herein. In some examples, forming the lay-up may include applying the polymer resin mixture having the sp² carbon-containing material therein to a plurality of fibers to form a layer having a selected distribution of sp² carbon-containing material therein, such as a higher concentration of sp² carbon-containing material on an outer facing surface of the plurality of fibers than on an inner facing surface thereof. In some examples, spraying the polymer (e.g., thermoset) resin or the mixture of the polymer resin and sp² carbon-containing material may be carried out at a pressure of less than about 90 psi onto the fiber fabric. In some examples, the polymer resin or the mixture of polymer resin and sp² carbon-containing material be manually spread onto the fiber fabric, such as by a spatula or the like. In some examples, the plurality of fibers may be provided as a pre-preg material, that is, a plurality of fibers containing at least some of the polymer resin or the mixture of polymer resin and sp² carbon-containing material, depending on the layer.

The polymer resin and sp² carbon-containing material combination may be applied to and/or embedded in the plurality of fibers by one or more of spraying, manually spreading (e.g., by trowel, roller, brush, or spatula), or otherwise coating. For example, a fiber layer having any of the densities disclosed herein can be coated by a predetermined mass of resin per square meter of fiber, such as any of the masses of resin per square meter of fiber disclosed herein.

Forming the lay-up may include affixing the affixing the sp² carbon-containing material on a plurality of fibers of the one or more polymer layers, such as the first and/or fourth polymer layers, as disclosed herein. For example, affixing the sp² carbon-containing material on the plurality of fibers may include growing the sp² carbon-containing material on the plurality of fibers, such via chemical vapor deposition as disclosed herein (e.g., using seed material) as disclosed herein. In such examples, affixing the sp² carbon-containing material on a plurality of fibers of the first polymer layer may include growing the sp² carbon-containing material on a first side of a fiber fabric via chemical vapor deposition.

In some examples, the forming the lay-up may include affixing the sp² carbon-containing material on a plurality of fibers of the first (and/or fourth) polymer layer(s) and orienting the sp² carbon-containing material (e.g., graphene flakes) in a direction parallel to a major axis of first (and/or fourth) polymer layer or composite sandwich as disclosed herein. For example, a magnetic field may be used to manipulate the orientation of the cobalt seed material after growing graphene thereon. Accordingly, the graphene on the seed material may be likewise manipulated by the magnetic field. In some examples, the plane or major axis of the sp² carbon-containing material in a selected layer may be oriented parallel, perpendicular, obliquely, or randomly to the major axis of the polymer layer, fiber sheet therein, or composite sandwich to selectively tune the heat release properties of the composite sandwich. In some examples, the sp² carbon-containing material may be grown in the selected orientation. For example, the seed material may be selectively positioned on the carbon fibers and the sp² carbon-containing material may be grown in the selected orientation by selectively controlling the CVD conditions.

Forming the lay-up may include providing one or more pre-molded polymer layers having sp² carbon-containing material therein as disclosed above. Spraying the mixture of polymer resin and sp² carbon-containing material on a fabric layer and then molding the layer allows the sp² carbon-containing material to be distributed on or throughout the polymer layer(s) having sp² carbon-containing material, and remain in places distributed on or throughout the polymer layer(s) having sp² carbon-containing material after molding. The remaining layers of the lay-up may be positioned in/on the pre-molded polymer layers having sp² carbon-containing material to provide at least a rough contour of the finished (e.g., molded) part. Accordingly, upon pressing the pre-molded polymer layer(s) and the remaining materials in the lay-up may be more readily pressed into the corners of the mold to give the full final form of the part defined by the mold. Forming the lay-up may include abrading the pre-molded polymer layer(s) on a surface that is intended to be bound to the additional polymer layer, or polymer layer having the sp² carbon-containing material, such as with a scouring pad, steel wool, a file, or any other tool suitable for abrading a surface.

In some examples, the (first) polymer layer having the sp² carbon-containing materials may include a plurality of glass fibers in thermoset resin, the additional (second) polymer layer may include a plurality of glass fibers or a plurality of carbon fibers in thermoset resin, additional (third) polymer layer may include a plurality of glass fibers or a plurality of carbon fibers in thermoset resin; and the (fourth) polymer layer having the sp² carbon-containing materials may include a plurality of glass fibers in thermoset resin. In some examples, the plurality of glass fibers or carbon fibers in a selected layer may have any of the densities disclosed herein such as having a density of 80 gsm, 220 gsm, 300 gsm, or the like. For example, the first polymer layer may include a first plurality of glass fibers having a density of 80 or 220 gsm and the sp2 carbon-containing material, the second polymer layer may include a second plurality of glass fibers having a density of 220 gsm or a plurality of carbon fibers having a density of 300 gsm, the third polymer layer may include a third plurality of glass fibers having a density of 220 gsm or a plurality of carbon fibers having a density of 300 gsm, and the fourth polymer layer may include a fourth plurality of glass fibers having a density of 80 or 220 gsm and the sp² carbon-containing material. In such examples, forming the lay-up may include applying an epoxy-polyurethane resin to one or more of the pluralities of fibers.

The core of the lay-up may include any of the cores disclosed herein such as a plurality of parallel tubes, a honeycomb core, a foam core, or the like. The core may have any of the material compositions or thicknesses disclosed herein. In some examples, forming a lay-up may include disposing further polymer layers, thermoplastic layers, aluminum layers, or the like in the lay-up.

The act 920 of pressing the lay-up in a mold may be as described above with respect to the method 900.

The act 930 of curing the lay-up to form a composite sandwich may be as described above with respect to the method 900.

The method 1100 may further include cooling the lay-up (e.g., now at least partially cured composite sandwich structure) after curing the lay-up. For example, the at least partially cured sandwich structure may be allowed to cool in ambient temperature, a refrigerated environment, a cooling tunnel, or by otherwise passing air over the sandwich structure.

The method 1100 may include utilizing resin transfer molding or a pre-preg to form the composite laminate structure. For example, the plurality of fibers (with or without sp² carbon-containing material attached thereto) may be placed into a lay-up in a mold and resin (with or without sp² carbon-containing material therein) may be injected into the mold such that the resin impregnates the plurality of fibers in the lay-up to form a composite laminate structure. In some examples, a lay-up including a pre-preg (with or without the sp² carbon-containing material therein) may be disposed within a mold and pressed in the mold to form a part. A resin (with or without sp² carbon-containing material therein) may be applied to the pre-preg prior to compressing the lay-up in the mold.

The method 1100 may include trimming flashing from the composite sandwich after curing the lay-up.

The composite sandwiches formed from the method 900, 1000, 1100 may include any of the shapes disclosed herein, any of the mechanical properties disclosed herein, or any of the heat release properties disclosed herein (e.g., below 70 kW*min/m²). The method 900, 1000, or 1100 may be used to form any of the composite sandwiches or composite laminate structures disclosed herein.

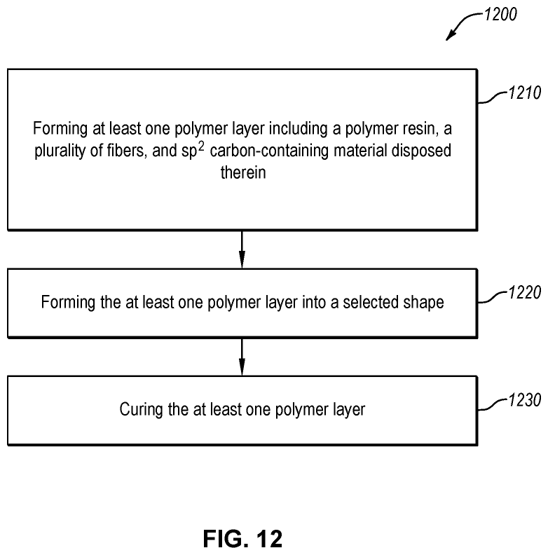

FIG. 12 is a flow chart of a method 1200 of making a monolithic composite, according to an embodiment. The method 1200 includes an act 1210 of forming at least one polymer layer including a polymer resin, a plurality of fibers, and sp² carbon-containing material disposed therein; an act 1220 of forming the at least one polymer layer into a selected shape; and an act 1230 of curing the at least one polymer layer. In some examples, the acts 1210, 1220, or 1230 may be performed in different order than presented or one or more acts may be omitted. In some examples, additional acts may be included in the method 1200. For example, embodiments of method 1200 also can include an act of painting or coating one or more outermost surface(s) of the at least one polymer layer with at least one of paint or a vinyl adhesive sticker. One or more portions of the method 1200 may be similar or identical to any portions of the methods 900, 1000, or 1000 in one or more aspects.

The act 1210 of forming at least one polymer layer including a polymer resin, a plurality of fibers, and sp² carbon-containing material disposed therein may include providing a plurality of polymer layers. The act 1210 of forming at least one polymer layer including a polymer resin, a plurality of fibers, and sp² carbon-containing material disposed therein may include providing or forming at least one polymer layer such as any of the first layer 610, the second layer 620, or the third layer 630. Forming the at least one polymer layer may include forming at least one layer having a polymer resin (e.g., any of the polymer resins herein), a plurality of fibers (e.g., any of the pluralities of fibers herein), and sp² carbon-containing material. For example, forming the at least one polymer layer may include applying a polymer resin having sp² carbon-containing material onto the plurality of fibers. In some examples, forming the at least one polymer layer may include affixing sp² carbon-containing material onto the plurality of fibers and then applying the polymer resin thereon, such as via growing the sp² carbon-containing material on the plurality of fibers. In some examples, the sp² carbon-containing material may be oriented in a selected direction (e.g., parallel planar to the a fiber sheet) as disclosed herein. Applying the polymer resin may include spraying, manually spreading, pouring, or otherwise applying the polymer resin onto the plurality of fibers in a selected distribution such as evenly on both sides or a greater amount on one side or portion of the plurality of fibers. The polymer resin or mixture of polymer resin and sp² carbon-containing material may be applied in liquid, semi-solid, or solid form. In some examples, the polymer resin, plurality of fibers, and sp² carbon-containing material may be provided in a pre-preg and forming the at least one polymer layer may include providing the pre-preg. In some examples, forming the at least one polymer layer may include mixing the sp² carbon-containing material with polymer resin to form a polymer resin mixture having a selected distribution of sp² carbon-containing material therein (e.g., a substantially uniform distribution). The polymer resin mixture may be applied to the plurality of fibers. Forming the at least one polymer layer may include pre-molding one or more of the at least one polymer layers.

In some examples, forming at least one polymer layer include mixing the sp² carbon-containing material with polymer resin to form a polymer resin mixture having a selected distribution of sp² carbon-containing material therein (e.g., a substantially uniform distribution). For example, a high-shear mixer or ultrasonic agitator may be used to mix polymer resin and sp² carbon-containing material in the amounts disclosed herein as disclosed above. The sp² carbon-containing material may be added as single wall graphene tubes, multi-wall graphene tubes, graphene powder, graphene sheets, graphene flakes, graphene spirals, patterned graphene, folded graphene, any of the sp² carbon-containing materials disclosed herein, or combinations of the any of the foregoing. The sp² carbon-containing material content of selected polymer layer may be any of the contents disclosed herein, such as less than 10 wt % or less than 4 wt % of the polymer layer.

The at least one polymer layer may be an as yet uncured layer or layers (e.g., stack) of a structural component to be formed. The at least one polymer layer may include a first polymer layer including sp² carbon-containing material therein; a second polymer layer disposed on the first polymer layer; and a third polymer layer (optionally including sp² carbon-containing material therein). Accordingly, the at least one polymer layer and resulting monolithic composite structure include at least one outermost surface having sp² carbon-containing material therein. Such examples provide relatively low heat release from any surface compared composite sandwiches without sp² carbon-containing material therein.

The act 1220 of forming the at least one polymer layer into a selected shape may include pressing the at least one polymer layer (having sp² carbon-containing material therein) in a mold. For example, forming the at least one polymer layer into a selected shape may include positioning the first layer 610, the second layer 620, or the third layer 630 in the mold. The mold may be as described above with respect to the method 900. The pressing the at least one polymer layer in a mold may be carried out as described above with respect to the method 900, in one or more aspects. For example, pressing the at least one polymer layer in a mold may include heat pressing the at least one polymer layer. Forming the at least one polymer layer into a selected shape may include positioning any of the layers disclosed herein into the mold, such positioning the first layer 610 in the mold, the second layer 620 on the first layer 610, and the third layer 630 on the second layer 620. In some examples, one or more of the second layer 620 or the third layer 630 may be omitted in the monolithic composite.

Forming the at least one polymer layer into a selected shape may include closing the mold and pressing the at least one polymer layer therein. Forming the at least one polymer layer into a selected shape may include pressing the at least one polymer layer in the mold for a select time. forming the at least one polymer layer into a selected shape may include placing the at least one polymer layer on a template or frame. The shape may include any of those shapes or composite components disclosed herein, such as a vehicle body panel, a seat component, a vehicle interior panel, a storage container panel, or the like.

Upon or after pressing, the polymer resin(s) or mixture of resin(s) and sp² carbon-containing material may infiltrate into the plurality of fibers and harden upon curing to form a cured polymer layer having sp² carbon-containing material therein.

The act 1230 of curing the at least one polymer layer may be similar or identical to the act 930 of curing the lay-up to form a composite sandwich as described above with respect to the method 900, in one or more aspects. For example, curing the at least one polymer layer may include curing the at least one polymer layer to form a monolithic composite part.

Curing the at least one polymer layer may include heating the monolithic layer in the mold to a curing temperature of the polymer resin therein. Curing the at least one polymer layer may include cooling the at least one polymer layer from the curing temperature such as to an below the curing temperature via removing from the mold, cooling in ambient air, cooling in a refrigerated environment, or the like. In some examples, the method 1200 may include removing the monolithic composite part from the mold.

The method 1200 may further include cooling the at least one polymer layer (e.g., now at least partially cured monolithic composite) after curing. For example, the at least partially cured monolithic structure may be allowed to cool in ambient temperature, a refrigerated environment, a cooling tunnel, or by otherwise passing air over the monolithic composite structure.

The method 1200 may include utilizing resin transfer molding or a pre-preg to form the composite structure. For example, the plurality of fibers (with or without sp² carbon-containing material attached thereto) may be placed into a lay-up in a mold and resin (with or without sp² carbon-containing material therein) may be injected into the mold such that the resin impregnates the plurality of fibers in the lay-up to form a composite laminate structure. In some examples, a lay-up including a pre-preg (with or without the sp² carbon-containing material therein) may be disposed within a mold and pressed in the mold to form a part. In some examples, the pre-preg may include sp² carbon-containing material affixed to the plurality of fibers as disclosed herein. A resin (with or without sp² carbon-containing material therein) may be applied to the pre-preg prior to pressing the at least one polymer layer in the mold.

The method 1200 may include trimming flashing from the monolithic composite part after curing. In some examples, the monolith composite part may be painted, pigmented, covered with a sticker (e.g., vinyl), or otherwise presented with a selected color, texture, and appearance, prior to or after curing.

### WORKING EXAMPLES

Working Example A was formed according to the following procedure. A mixture of thermoset resin (epoxy-polyurethane mixture) and single-wall carbon nanotubes (“SWCNT”) was formed in a high-shear mixer. The SWCNTs were 2 wt % of the mixture. A 80 g/m² plain weave glass fiber fabric was provided. The mixture of thermoset resin and SWCNT was applied to the glass fiber fabric at 48 g/m² to form the thermoset layer having the SWCNTs therein. The thermoset layer having the SWCNTs was pressed and heated. A 220 g/m² glass skin containing an epoxy/polyurethane thermoset resin was applied to the thermoset layer having the SWCNT. A core having a plurality of 4 mm thick (e.g., from open end to open end) PEI tubes was disposed on the still wet (uncured) second thermoset layer. An NCF carbon fiber sheet having an epoxy/polyurethane resin applied thereto (third thermoset layer) was disposed on the opposite side of the core from the second thermoset layer to form the lay-up of Working Example A. The lay-up was pressed and cured to solidify the additional thermosets to form Working Example A. Working Example A was about 3.6 mm thick and planar.

Working Example B was formed according to the following procedure. A mixture of thermoset resin (epoxy-polyurethane mixture) and SWCNT was formed in a high-shear mixer. The SWCNTs were 4 wt % of the mixture. A 80 g/m² plain weave glass fiber fabric was provided. The mixture of thermoset resin and SWCNTs was applied to the glass fiber fabric at 48 g/m² to form the thermoset layer having the sp² carbon-containing material. The thermoset layer having the SWCNTs was pressed and heated. A 220 g/m² glass skin containing an epoxy/polyurethane thermoset resin (second thermoset layer) was applied to the thermoset layer. A core having a plurality of 4 mm thick (e.g., from open end to open end) PEI tubes was disposed on the still wet (uncured) second thermoset layer. An NCF carbon fiber sheet having an epoxy/polyurethane resin applied thereto (third thermoset layer) was disposed on the opposite side of the core from the second thermoset layer to form the lay-up of Working Example B. The lay-up was pressed and cured to solidify the thermosets to form Working Example B. Working Example B was about 4.2 mm thick and planar.

Working Example C was formed according to the following procedure. A mixture of thermoset resin (epoxy-polyurethane mixture) and SWCNT was formed in a high-shear mixer. The SWCNTs were 4 wt % of the mixture. A 80 g/m² plain weave glass fiber fabric was provided. The mixture of thermoset resin and SWCNTs was applied to the glass fiber fabric at 48 g/m² to form the thermoset layer having the sp² carbon-containing material. The thermoset layer having the SWCNTs was pressed and heated. A 220 g/m² glass skin containing an epoxy/polyurethane thermoset resin (second thermoset layer) was applied to the thermoset layer. A 4 mm thick PMI-based foam core having a plurality of cells was disposed on the still wet (uncured) second thermoset layer. An NCF carbon fiber sheet having an epoxy/polyurethane resin applied thereto (third thermoset layer) was disposed on the opposite side of the core from the second thermoset layer to form the lay-up of Working Example C. The lay-up was pressed and cured to solidify the thermosets to form Working Example C. Working Example C was about 3.8 mm thick and planar.

Working Example D was formed according to the following procedure. A mixture of thermoset resin (epoxy-polyurethane mixture) and SWCNT was formed in a high-shear mixer. The SWCNTs were 6 wt % of the mixture. A 80 g/m² plain weave glass fiber fabric was provided. The mixture of thermoset resin and SWCNTs was applied to the glass fiber fabric at 48 g/m² to form the thermoset layer having the sp² carbon-containing material. The thermoset layer having the SWCNTs was pressed and heated. A 220 g/m² glass skin containing an epoxy/polyurethane thermoset resin (second thermoset layer) was applied to the thermoset layer. A core having a plurality of 4 mm thick (e.g., from open end to open end) PEI tubes was disposed on the still wet (uncured) second thermoset layer. An NCF carbon fiber sheet having an epoxy/polyurethane resin applied thereto (third thermoset layer) was disposed on the opposite side of the core from the second thermoset layer to form the lay-up of Working Example D. The lay-up was pressed and cured to solidify the thermosets to form Working Example D. Working Example D was about 3.8 mm thick and planar.

Working Example E was formed according to the following procedure. A mixture of thermoset resin and SWCNT was formed in a high-shear mixer. The SWCNTs were 8 wt % of the mixture. A 80 g/m² plain weave glass fiber fabric was provided. The mixture of thermoset resin and SWCNTs was applied to the glass fiber fabric at 48 g/m² to form the thermoset layer having the sp² carbon-containing material. The thermoset layer having the SWCNTs was pressed and heated. A 220 g/m² glass skin containing an epoxy/polyurethane thermoset resin (second thermoset layer) was applied to the thermoset layer. A core having a plurality of 4 mm thick (e.g., from open end to open end) PEI tubes was disposed on the still wet (uncured) second thermoset layer. An NCF carbon fiber sheet having an epoxy/polyurethane resin applied thereto (third thermoset layer) was disposed on the opposite side of the core from the second thermoset layer to form the lay-up of Working Example E. The lay-up was pressed and cured to solidify the thermosets to form Working Example E. Working Example E was about 3.7 mm thick and planar.

Working Example F was formed according to the following procedure. A 80 g/m² plain weave glass fiber fabric was provided. A PEI resin was applied to the glass fiber fabric, pressed, and heated to form a thermoplastic layer. A mixture of thermoset resin (epoxy-polyurethane mixture) and SWCNT was formed in a high-shear mixer. The SWCNTs were 8 wt % of the mixture. A 220 g/m² glass fiber skin was provided. The mixture of thermoset resin and SWCNTs was applied to the glass fiber skin at 48 g/m² to form the thermoset layer having the sp² carbon-containing material. The thermoset layer having the SWCNTs was pressed and heated. The thermoset layer having the SWCNTs was applied to the thermoplastic layer. A 4 mm thick PEI honeycomb core was disposed on the still wet first thermoset layer having the SWCNTs therein. An NCF carbon fiber sheet having an epoxy/polyurethane resin applied thereto (second thermoset layer) was disposed on the opposite side of the core from the first thermoset layer to form the lay-up of Working Example F. The lay-up was pressed and cured to solidify the thermosets to form Working Example F. Working Example F was about 4.7 mm thick and planar.

Comparative Example 1 was formed according to the following procedure. A 80 g/m² plain weave glass fiber fabric was provided. The thermoset resin (epoxy-polyurethane mixture) was applied to the glass fiber fabric at 48 g/m² to form the first thermoset layer. The first thermoset layer was pressed and heated. A 0.1 mm layer of aluminum foil was applied to the first thermoset layer, and a 220 g/m² glass skin containing 132 g/m² epoxy-polyurethane thermoset resin (second thermoset layer) was applied to the layer of aluminum foil. A core having a plurality of 4 mm thick (e.g., from open end to open end) PEI tubes was disposed on the still wet (uncured) second thermoset layer. An NCF carbon fiber sheet having an epoxy/polyurethane resin applied thereto (third thermoset layer) was disposed on the opposite side of the core from the second thermoset layer to form the lay-up of Comparative Example 1. The lay-up was pressed and cured to solidify the thermosets to form Comparative Example 1. Comparative Example 1 was about 4.1 mm thick and planar.

Three samples of each of Working Examples A-E, and Comparative Example 1 were tested for heat release according to the testing procedures set forth in 14 C.F.R. pt. 25, Appendix F, Part IV(a)-(h) (2011). Testing revealed that Working Example A had an average heat release of 68.2 kW*min./m² and an average peak heat release of 58.2 kW*min./m². Testing revealed that Working Example B had an average heat release of 63.0 kW*min./m² and an average peak heat release of 53.0 kW*min./m². Testing revealed that Working Example C had an average heat release of 28.3 kW*min./m² and an average peak heat release of 57.8 kW*min./m². Testing revealed that Working Example D had an average heat release of 61.4 kW*min./m² and an average peak heat release of 50.5 kW*min./m². Testing revealed that Working Example E had an average heat release of 57.0 kW*min./m² and an average peak heat release of 45.3 kW*min./m². Testing revealed that Working Example F had an average heat release of 26.3 kW*min./m² and an average peak heat release of 28.6 kW*min./m². Testing also revealed that Comparative Example 1 had an average heat release of 86.8 kW*min./m² and an average peak heat release of 105.9 kW*min./m².

The heat release values of Working Examples A-E were surprising as it was initially believed that the heat release would we similar or identical to heat release values obtained for a lay-up having a standard first thermoset layer and an aluminum foil layer similar to Comparative Example 1, which were above 86 kW*min./m². However, each of Working Examples A-E demonstrated superior heat release compared to Comparative Example 1.

Accordingly, by removing the aluminum foil layer of Comparative Example 1 and adding sp² carbon-containing material (e.g., SWCNTs) to the thermoset layer (e.g., thermoset layer having sp² carbon-containing material) of Working Examples A-E, a composite sandwich structure may have a greatly reduced heat release. Moreover, the average peak heat release for Working Example A and both the average heat release and the average peak heat release for Working Examples B-F were within aviation safety standards. By adding 2 wt % more SWCNTs in Working Example B than was used in Working Example A, the heat release of similarly constructed composite laminates was lowered by about 5 kW*min./m². Similar 2% increases in SWCNT amounts in working examples D and E resulted in further decreases in heat release values. The inventor currently believes that by increasing the amount of sp² carbon-containing material in the thermoset layer having sp² carbon-containing material, the heat release of composite laminates utilizing said layer can be further lowered beyond the above demonstrated results. Accordingly, the costly step of adding an aluminum layer to deflect heat away from the inner components of a composite sandwich structure can be safely omitted by using the composite sandwich structures disclosed herein.

Working Example C showed a very low average heat release (28.3 kW*min./m²) and a peak heat release of 57.8 kW*min./m². When compared to Working Example B, which only differs from Working Example C in the core material, Working Example C showed a lower average heat release but a higher peak heat release. These values demonstrated that the foam core of Working Example C delayed the timing of the peak heat release by approximately 100 seconds compared to the PEI core used in Working Example B. Accordingly, utilizing a PMI-based foam core in combination with the layer having sp² carbon-containing material may delay peak heat release in composite sandwich structures and provide heat release values that satisfy aviation standards.

The average heat release values of Working Example F were very low and the average peak heat release was nearly the same as the average heat release through the entire duration of the test. Accordingly, utilizing a high-temperature thermoplastic resin in combination with one or more layers having sp² carbon containing material therein depresses the maximum magnitude (e.g., peak) of the heat released from composite parts.

The composite sandwiches disclosed herein may have relatively low heat release, high sound absorption, high heat insulation, high bending stiffness, high energy absorption, and light weight. Similar or even lower heat release results are expected for monolithic composites due to the lack of a core therein. The composite sandwiches and monolithic composites disclosed herein may be used in various applications including in the auto industry, agricultural equipment, rail applications (e.g., engine or railcar interiors, seats, bulkheads, etc.), bicycles, satellite applications, aerospace applications (e.g., airplane interiors, seats, bulkheads, etc.), marine applications (e.g., boats), rail applications (e.g., train car interiors, seats, etc.), construction materials, consumer products (e.g., furniture, toilet seats, and electronic products among others), etc.

While various aspects and embodiments have been disclosed herein, other aspects and embodiments are contemplated. The various aspects and embodiments disclosed herein are for purposes of illustration and are not intended to be limiting.

1. A composite sandwich structure, comprising:
a first polymer layer including sp² carbon-containing material therein;
a second polymer layer disposed on the first polymer layer;
a core positioned on the second polymer layer, wherein the core includes a plurality of cells; and
a third polymer layer disposed on the core substantially opposite the second polymer layer.

2. The composite sandwich structure of claim 1, wherein the sp² carbon-containing material includes one or more of graphene sheets, graphene flakes, graphene spirals, patterned graphene, single-wall carbon nanotubes, multi-wall carbon nanotubes, or fullerenes.

3. The composite sandwich structure of claim 1, wherein the sp² carbon-containing material is less than 10 wt % of the first polymer layer.

4. (canceled)

5. The composite sandwich structure of claim 1, wherein:
the first polymer layer includes a plurality of glass fibers;
the second polymer layer includes a plurality of glass fibers or a plurality of carbon fibers; and
the third polymer layer includes a plurality of glass fibers or a plurality of carbon fibers.

6. The composite sandwich structure of claim 1, wherein the plurality of cells includes a plurality of polyetherimide cells.

7. The composite sandwich structure of claim 1, wherein the composite sandwich structure has a heat release below 70 kW*min/m².

8. The composite sandwich structure of claim 1, wherein the sp² carbon-containing material includes graphene flakes.

9. The composite sandwich structure of claim 1, wherein:
the first polymer layer includes a glass fiber sheet; and
the sp² carbon-containing material includes a plurality of graphene flakes affixed to the glass fiber sheet on an outward facing portion thereof.

10. The composite sandwich structure of claim 9, wherein the plurality of graphene flakes are oriented in a direction parallel to a major axis of first polymer layer.

11. The composite sandwich structure of claim 1, wherein the sp² carbon-containing material includes single-wall carbon tubes evenly distributed throughout the first polymer layer.

12. The composite sandwich structure of claim 1, wherein the sp² carbon-containing material is distributed throughout the first polymer layer in a higher weight percentage in an outer portion thereof than an inner portion thereof.

13. The composite sandwich structure of claim 1, wherein:
the first polymer layer includes a first plurality of glass fibers having a density of 80 grams per square meter (“gsm”), an epoxy-polyurethane resin, and graphene flakes;
the second polymer layer includes a second plurality of glass fibers having a density of 220 gsm and an epoxy-polyurethane resin; and
the third polymer layer includes a plurality of carbon fibers having a density of 300 gsm and an epoxy-polyurethane resin.

14. The composite sandwich structure of claim 13, wherein the plurality of cells include one or more of a plurality of tubes bonded together in parallel or a polymethacrylimide-based foam.

15. (canceled)

16. (canceled)

17. The composite sandwich structure of claim 1, further comprising a high-temperature thermoplastic layer disposed on the first polymer layer.

18. (canceled)

19. The composite sandwich structure of claim 1, wherein the composite sandwich structure is shaped as a vehicle body panel, a seat component, a vehicle interior panel, or a storage container panel.

20. (canceled)

21. (canceled)

22. (canceled)

23. (canceled)

24. A composite sandwich structure, comprising:
a first polymer layer including sp² carbon-containing material therein;
a second polymer layer disposed on the first polymer layer;
a core positioned below the second polymer layer, wherein the core includes a plurality of cells;
a third polymer layer positioned below the core; and
a fourth polymer layer including sp² carbon-containing material therein positioned below the third polymer layer.

25. (canceled)

26. The composite sandwich structure of claim 24, wherein sp² carbon-containing material is substantially evenly distributed throughout the first polymer layer and the fourth polymer layer.

27. The composite sandwich structure of claim 24, wherein the sp² carbon-containing material is distributed throughout the first polymer layer and the fourth polymer layer in a higher weight percentage in an outer portion than an interior facing portion thereof.

28. A method of making a composite, the method comprising:
forming a lay-up, including:
a first polymer layer having sp² carbon-containing material therein;
a second polymer layer disposed on the first polymer layer;
a core positioned on the second polymer layer, wherein the core includes a plurality of cells; and
a third polymer layer disposed on the core substantially opposite the second polymer layer;
pressing the lay-up in a mold; and
curing the lay-up to form a composite sandwich.

29. The method of claim 28, wherein forming a lay-up includes:
mixing the sp² carbon-containing material with polymer resin to form a polymer resin mixture having a substantially uniform distribution of sp² carbon-containing material therein; and
applying the polymer resin mixture to a glass fiber fabric to form the first polymer layer.

30. The method of claim 28, wherein forming a lay-up includes:
affixing the sp² carbon-containing material on a plurality of fibers of the first polymer layer; and
applying a polymer resin to the plurality of fibers and sp² carbon-containing material therein.

31. (canceled)

32. The method of claim 30, wherein:
the sp² carbon-containing material includes graphene flakes; and
affixing the sp² carbon-containing material on a plurality of fibers of the first polymer layer includes orienting the graphene flakes in a direction parallel to a major axis of first polymer layer.

33. The method of claim 28, wherein the sp² carbon-containing material includes one or more of carbon nanotubes, graphene sheets, or graphene flakes.

34. The method of claim 28, wherein the sp² carbon-containing material is less than 10 wt % of the first polymer layer.

35. The method of claim 28, wherein the plurality of cells include one or more of a plurality of tubes bonded together in parallel or a polymethacrylimide-based foam.

36. (canceled)

37. The method of claim 28, wherein:
the first polymer layer includes a plurality of glass fibers;
the second polymer layer includes a plurality of glass fibers or a plurality of carbon fibers; and
the third polymer layer includes a plurality of glass fibers or a plurality of carbon fibers.

38. The method of claim 28, wherein:
the first polymer layer includes a first plurality of glass fibers having a density of 80 grams per square meter (“gsm”) and the sp² carbon-containing material;
the second polymer layer includes a second plurality of glass fibers having a density of 220 gsm;
the third polymer layer includes plurality of carbon fibers having a density of 300 gsm; and
and forming a lay-up includes applying an epoxy-polyurethane resin to one or more of the first plurality of glass fibers, the second plurality of glass fibers, or the plurality of carbon fibers.

39. The method of claim 28, wherein the composite sandwich has a heat release below 70 kW*min/m².

40. The method of claim 28, wherein forming a lay-up includes disposing a high-temperature thermoplastic layer on the first polymer layer.

41.

[symbol]

42. The method of claim 28, wherein pressing the lay-up in a mold includes pressing the lay-up in a heated mold.

43. The method of claim 28, wherein curing the lay-up to form the composite sandwich includes one or more of heating the lay-up while pressing the lay-up in the mold or allowing the lay-up to cool to an ambient temperature after pressing the lay-up in the mold.

44. (canceled)

45. (canceled)

46. (canceled)

47. (canceled)

48. (canceled)

49. (canceled)

50. (canceled)
